(19) United States
(12) Patent Application Publication
(10) Pub. No.: US 2010/0281313 A1
(43) Pub. Date: Nov. 4, 2010

(54) DYNAMICALLY GENERATED WEB SURVEYS FOR USE WITH CENSUS ACTIVITIES, AND ASSOCATED METHODS

(75) Inventors: John WHITE, Ashburn, VA (US); Russell E. Chandler, Gaithersburg, MD (US); Frederic Highland, New Midway, MD (US)

Correspondence Address: NIXON & VANDERHYE, PC, 901 NORTH GLEBE ROAD, 11TH FLOOR, ARLINGTON, VA, 22203, US

(73) Assignee: LOCKHEED MARTIN CORPORATION, Bethesda, MD (US)

(21) Appl. No.: 12/435,139

(22) Filed: May 4, 2009

Related U.S. Application Data
(63) Continuation of application No. 12/435,079, filed on May 4, 2009.

(51) Int. Cl. G06F 17/00; G06F 11/07; G06F 3/01

(52) U.S. Cl. 714/57; 715/222; 715/708; 714/48; 714/E11.025; 714/E11.024

(57) ABSTRACT

Certain example embodiments disclosed herein relate to online survey systems and/or methods. In certain example embodiments, the questions to be asked are substantially insulated from an application that asks the questions. This abstraction may be accomplished in certain example embodiments by dynamically generating a computer-accessible (e.g., web-based) survey from one or more definition files. For example, a survey may be defined via a response definition file and a user interface definition file, thereby enabling the definition files to be read and the survey to be presented with the appropriate questions, validations, and transformations being specified by the response definition file, and with the look and feel being specified by the user interface definition file. Answers to questions may be persisted for a respondent in a storage location remote from the respondent. Such online surveys systems and/or methods may be suitable for census-related activities.

### FIELD OF THE INVENTION

The example embodiments disclosed herein relate to online surveys and, more particularly, the example embodiments disclosed herein relate to online surveys suitable for use with census activities. In certain example embodiments, the questions to be asked are substantially insulated from the application that asks the questions. This abstraction may be accomplished in certain example embodiments by dynamically generating a computer-accessible (e.g., web-based) survey from one or more definition files. A survey in accordance with an example embodiment may be defined via a response definition file and a user interface definition file, thereby enabling the definition files to be read and the survey to be presented, with the appropriate questions, validations, and transformations being specified by the response definition file and with the look and feel being specified by the user interface definition file.

### BACKGROUND AND SUMMARY OF THE INVENTION

Governments must understand their populations to strengthen their economics, foster just societies, and protect their people. Census data plays a critical role in achieving these ends, forming the empirical backbone of information on the surveyed users or respondents. It would be advantageous to accomplish census data gathering through a flexible, low-risk process that ensures data quality, integrity, and confidentiality. Furthermore, the increased emphasis on evidence-based policymaking and effective performance management makes a successful census all the more crucial.

In general, then, a census should help to provide high quality statistics that provide consistent and coherent outputs. This data, in turn, may be seen by the users to be accurate, a good value for money, and fit for its purposes. These efforts thus help to build public and stakeholder confidence in the results of the census. The data advantageously may be kept secure, and the census solution may be designed to protect the confidentiality of the census data.

Although some existing online survey tools represent an improvement over traditional survey techniques, further improvements are still possible. For example, existing online survey tools typically are implemented as custom web applications specifically designed for the details of the survey in an enterprise integration architecture. This design choice reduces the case with which surveys may be changed or modified, makes it more difficult to integrate such surveys with other related activities (e.g., other forms of survey collection) and components (e.g., backend servers, databases, etc.), and frequently does not scale to the level needed for many large-scale survey applications (e.g., census related activities). Questions often cannot be dynamically generated (e.g., there is no questionnaire logic or the questionnaire logic that is provided is lacking) and often are not served up in a manner that is substantially platform independent. Navigation through a long or complex survey (e.g., surveys having multiple parts and/or sub-parts that may be required or optional depending upon a previous answer) typically is burdensome and/or confusing. Thus, it will be appreciated that such survey techniques generally are not well-suited for mass completion by the public, e.g., as would be required for a census related activity.

Thus, it will be appreciated that there is a need in the art for systems and/or methods that overcome one or more of these and/or other disadvantages. It also will be appreciated that there is a need in the art for dynamically generated web surveys for use with census activities, and associated methods.

In certain example embodiments, a computer-readable storage medium tangibly embodying a forms engine configured to dynamically generate a computer-accessible online survey comprising a plurality of response pages for a respondent to complete in connection with the online survey is provided. Programmed logic circuitry may be configured to (1) read a response definition template and a user interface definition template, with the response definition template being indicative of questions to be asked to the respondent and validations and transformations to be applied to the questions, and (2) arrange the response pages in dependence on the user interface definition template. The programmed logic circuitry may be further configured to persist in a storage location responses to questions provided to the response pages by the respondent, with the storage location being remote from the respondent. The response definition template and the user interface definition template may be substantially independent of one another.

In certain example embodiments, a computer-accessible online survey system is provided. A plurality of response pages may be provided for a respondent to complete in connection with the online survey. A forms engine may be configured to dynamically generate the survey. The forms engine may be configured to: (1) read a response definition template and a user interface definition template, with the response definition template being indicative of questions to be asked to the respondent and validations and transformations to be applied to the questions, and (2) arrange the response pages in dependence on the user interface definition template, and (3) persist in a storage location responses to questions provided to the response pages by the respondent, with the storage location being remote from the respondent. The response definition template and the user interface definition template may be substantially independent of one another.

In certain example embodiments, a method of conducting a computer-accessible online survey is provided. A response definition template and a user interface definition template may be read. The response definition template may be indicative of questions to be asked to the respondent and validations and transformations to be applied to the questions. A plurality of response pages may be dynamically generated for a respondent to complete in connection with the online survey. The response pages may be arranged in dependence on the user interface definition template. Responses to questions provided to the response pages by the respondent may be persisted in a storage location remote from the respondent. The response definition template and the user interface definition template may be substantially independent of one another.

In certain example embodiments, a computer-readable storage medium tangibly storing a schema is provided. The schema is readable by a forms engine configured to dynamically conduct a computer-accessible online survey in dependence on the schema. The schema comprises a plurality of elements arranged hierarchically. Each said element comprises one or more elements and/or attributes. Each said attribute includes descriptive information associated with a corresponding element. Pointers are associated with at least some of the elements and/or attributes. The pointers point to text and/or images to be selectively included in the online survey but are stored separately from the schema such that the schema is substantially free from hard-coded text and/or images that otherwise would be included in the online survey. At least some of the elements and/or attributes dynamically instruct the forms engine whether to ask, repeatedly ask, or skip a question or section of questions pointed to by one or more of said pointers.

In certain example embodiments, a method of conducting a computer-accessible online survey is provided. The method comprises presenting one or more response pages for a respondent to complete in connection with the online survey. The one or more response pages are dynamically generated by a forms engine in dependence on a schema tangibly stored in a computer-readable storage medium. The schema comprises a plurality of elements arranged hierarchically. Each said element comprises one or more elements and/or attributes. Each said attribute includes descriptive in formation associated with a corresponding element. Pointers are associated with at least some of the elements and/or attributes. The pointers point to text and/or images to be selectively included in the online survey but are stored separately from the schema such that the schema is substantially free from hard-coded text and/or images that otherwise would be included in the online survey. At least some of the elements and/or attributes dynamically instruct the forms engine whether to ask, repeatedly ask, or skip a question or section of questions pointed to by one or more of said pointers.

In certain example embodiments, a system for conducting a computer-accessible online survey is provided. A schema is tangibly stored in a computer-readable storage medium. A forms engine is configured to dynamically process the schema in conducting the survey. The schema comprises a plurality of elements arranged hierarchically. Each said element comprises one or more elements and/or attributes. Each said attribute includes descriptive information associated with a corresponding element. Pointers are associated with at least some of the elements and/or attributes. The pointers point to text and/or images to be selectively included in the online survey but are stored separately from the schema such that the schema is substantially free from hard-coded text and/or images that otherwise would be included in the online survey. At least some of the elements and/or attributes dynamically instruct the forms engine whether to ask, repeatedly ask, or skip a question or section of questions pointed to by one or more of said pointers.

It will be appreciated that certain example embodiments of this invention may include or be provided as any suitable combination of programmed logic circuitry (e.g., hardware, software, firmware, and/or the like). Additionally, it will be appreciated that various elements of a system and/or method may be tangibly stored on a computer-readable medium.

The aspects, features, advantages, and example embodiments described herein may be combined in any suitable combination or sub-combination to realize yet further embodiments of this invention.

### BRIEF DESCRIPTION OF THE DRAWINGS

FIG. 1 is an example questionnaire printing, delivery, and data capture flow in accordance with an example embodiment;

FIG. 2 is an example Internet data capture channel in accordance with an example embodiment;

FIG. 3 shows the operational concept of an illustrative Internet data capture channel in accordance with an example embodiment;

FIG. 4 is an example web user interface refinement process that may be used in connection with certain example embodiments;

FIG. 5 is an example architecture of an Internet services cluster in accordance with an example embodiment;

FIG. 6 shows certain Internet data capture user interface design features available through certain example embodiments;

FIG. 7 is an illustrative, high-level context diagram in accordance with certain example embodiments;

FIG. 8 is an illustrative use case diagram in accordance with certain example embodiments;

FIG. 9 is an example architecture stack in accordance with an example embodiment;

FIGS. 10A-C show an example XML schema definition in accordance with an example embodiment;

FIG. 11 is a more generalized form definition schema in accordance with an example embodiment;

FIG. 12 shows example system tiers in accordance with an example embodiment;

FIG. 13 is an example database usable in a data layer or persistence tier in an illustrative system in accordance with an example embodiment;

FIG. 14 is an illustrative DataAccessBean in accordance with an example embodiment;

FIG. 15 is an example AnswerProcessor JAVA class in accordance with an example embodiment;

FIG. 16 is an example QuestionManager JAVA class in accordance with an example embodiment;

FIG. 17 is an example FormsManager JAVA class in accordance with an example embodiment;

FIG. 18 is an example RWProcessor JAVA class in accordance with an example embodiment;

FIG. 19 is an example page layout showing example page elements in accordance with an example embodiment; and

FIGS. 20A-G show an example XML schema definition in accordance with an example embodiment.

### DETAILED DESCRIPTION

### 1. Census Service Operational and Technical Overview

As alluded to above, a census is designed to gather the statistics for a population of interest and to deliver the data on time. In this vein, the census service may (1) provide the general public with multiple, easy-to-use, and secure methods of response; (2) collect and capture the data accurately and completely; and (3) provide a predictable and reliable process to deliver the data. Technology and management tools that allow timely reporting, analysis, and correlation of the status of the wide range of activities involved, and the ability to identify, execute and track corrective actions may be provided to help realize these aspects of a successful census.

This section provides a broad overview of the operational and technical approaches that an example advantageous census service may incorporate in realizing the above-noted and/or other aspects of a successful census.

1.1 Introduction to Technical Census Services

A baseline census solution may provide some or all of the following example features:
An operationally proven, linearly scaleable architecture;
Multiple capture channels with integrated output to provide high-quality results;
A census-optimized, highly-accurate paper data capture providing cost-effective quality results;
An industry-standard Internet architecture with security to reduce risk;
A flexible contact center;
A centralized, flexible response collection and analysis to address evolving business rules;
A cost-effective field force management and automation approach that is substantially fully integrated with the data capture and operational intelligence; and/or
A business intelligence approach to operations intelligence to provide the information needed to ensure success of the census.

As compared to existing survey techniques and other census solutions (including, for example, paper data collection solutions), the census service architecture of certain example embodiments may provide some or all of the following features:
Flexibility and consistency of response definition—The definition, presentation, and existence of individual responses may be subject to constant statistical, political, and/or social scrutiny. These aspects may change during the project, and at the last minute before the census. The data collected advantageously may be statistically consistent across multiple response modes. This may be accomplished by incorporating the flexibility to support changing response definitions and a means to maintain consistency across response channels.
Provably scalable from test and rehearsal to operations—Census operations advantageously may scale from development and rehearsal environments to full scale census operations. It has been observed that scalability around two orders of magnitude may be required. In addition, there typically is only one opportunity to conduct a census (e.g., particularly a decennial census). Accordingly, certain example embodiments may be architected so that test results in the lab and rehearsal systems can be reliably scaled to operational sizes and that testing is done in a way that is affordable.
Partitioned for verifiability and manageability—A census service is a complex collection of functions that should be built and operated reliably to achieve success. It advantageously may be logically partitioned into units with a common logical and functional theme that can be separately designed, implemented, tested, and operated. It also advantageously may include a complete set of management tools allowing operations staff from the lowest level of team leaders to the highest level of the census agency to know the status of the system.
Accuracy and completeness—As explained above, the results of a census may be critical to the planning of an entire nation. Thus, the results should be indicative of the responses submitted, and the associated data should be collected reliably. As such, quality assessment mechanisms may be built in at some or all levels of data collection, mechanisms may report and analyze quality, failsafe checks may be built into the system to help ensure complete processing, and manual operations may be kept simple to reduce the likelihood of errors being introduced.
Secure—The service may preserve the public trust by providing protection of the data collected, preserving the integrity of that data, and taking reasonable measures to assure the public their data is safe.
A short term enterprise—The census service only operates for a short period (e.g., typically about 3 months). Thus, there is little chance for adaptation during the census itself. Thus, the census activities of certain example embodiments may be affordable within the tight timeframe so as to be able to pay back any significant investment in personnel, equipment, or services is limited.

1.2 Broad Overview of Example Census Service Architecture

The census service architecture of certain example embodiments may integrate the printing, data capture, public interface, and operational intelligence functions. It also may be physically deployed to achieve availability, responsiveness, low risk, and cost effectiveness.

Certain example embodiments may provide for accurate data capture and quality assessment, integration of multiple response channels, standardization of response data, and delivery of images and data. The scope and scale of many census operations may place an additional focus on the management of the census data collection enterprise operations, and integration of the field operations into the process. This principal may be thought of as being a sort of operational intelligence. This may be addressed by providing facilities to gather and disseminate intelligence about the census operation to help ensure that it functions efficiently, effectively, and substantially fully integrates field force operations into the solution.

A census logical architect in accordance with an example embodiment may include, for example, a number of segments corresponding to capture channels and management functions, thereby resulting in a solution that is verifiable, manageable, maximizes flexibility and availability, and is optimized for processing census data.

Functional areas may include, for example, data capture, public interface, operational intelligence, and printing. In this example architecture, the data capture and public interface operational areas have been combined and redistributed into paper capture, Internet, and telephone segments based on the management, deployment, technical, and security needs of the different collection and communication modes. The segments may collect and convert respondent information into a standardized form that operational intelligence integrates and delivers. Similarly, the operational intelligence functional area may be divided into enterprise data management (EDM), production data management (PDM), system administration or management, and field support segments. Management of hardware, software, and networks may be focused in the system management segment, while the field force management may be addressed by the field support segment.

1.3 Example Application to Census Business Process

The following sections discuss how the components of the solution of certain example embodiments implement certain census services. This follows the major phases of the census, including address checking, delivery and data capture, non-response follow-up, and post-census surveys.

1.3.1 Example Optional Pre-Delivery/Address Checking

Pre-delivery activities center on preparing the address list for the census. It may begin with a list of household addresses, provided by the Authorities that seeds the address management database of the Enterprise Data Management (EDM) segment. This data may be used to distribute work to the field force through the field support segment. Address checkers then may verify the existence and characteristics of each of their allocated households. The field force may use mobile devices to verify the addresses, add newly built households, and delete those that are no longer occupied. Updates to the address lists may be securely transmitted by mobile device to the field support segment, applied to the EDM address management database, and verified by the authorities. This may allow management staff to track the current progress of address checking through the portal. It also may allow field managers at all levels to track detailed address checker progress through facilities of the held support segment.

1.3.2 Example Questionnaire Printing, Delivery, and Data Capture

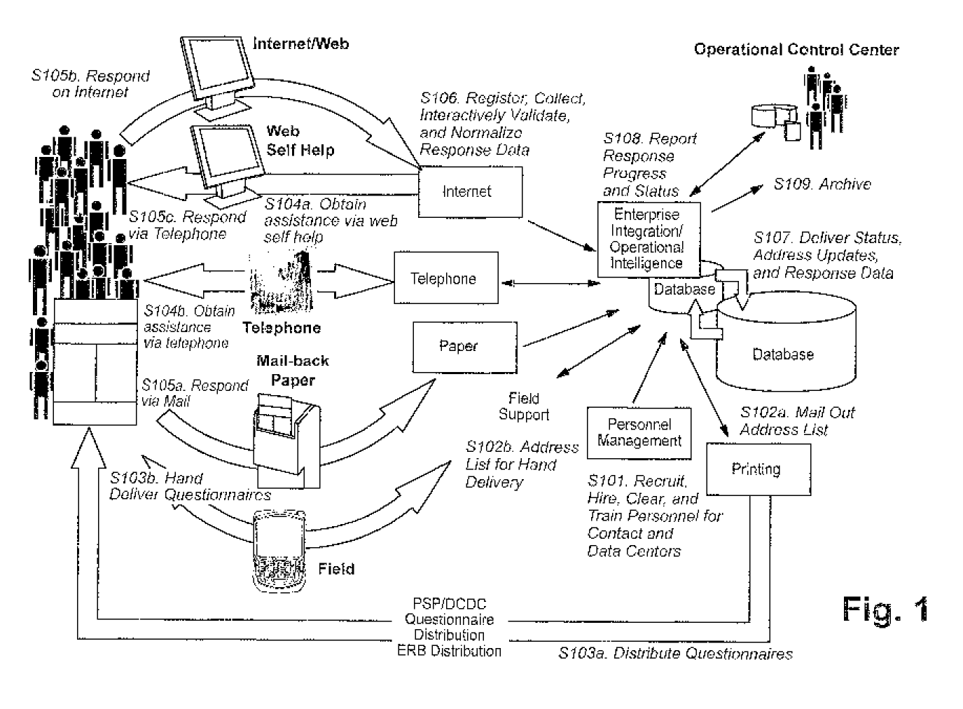

FIG. 1 is an example questionnaire printing, delivery, and data capture flow in accordance with an example embodiment. Prior to beginning the delivery phase, a contractor may recruit, hire, security clear, and train personnel for data center and contact center operations (Step S101). Using the data from the address management database, the census questionnaires can be printed, addresses applied by the printing segment (Step S102a) and provided to the postal service provider or data center distribution contractor for distribution (Step S103a). For hand delivery and special enumeration areas, task lists are provided to the field force via the field support segment (Step S102b) for hand delivery (Step S103b). Enumerator Record Books (ERBs) also may be printed and distributed in preparation for the delivery phase. The public can request assistance and additional questionnaires using either the web self-help facility (Step S104a) or the contact center (Step S104b) to enable them to complete their questionnaires. Responses can then be made using mail-back paper (Step S105a), Internet (Step S105b), or optional telephone (Step S105c) response channels. The paper, Internet, and optional telephone segments provide the users with support to enter, register, and validate the data. The completed responses are forwarded to EDM where they are standardized, edited, coded (by the coding segment), and stored (Step S106). The completed data is delivered along with any address additions and updates and processing status (Step S107). During the printing, distribution, data capture, and assistance process, progress and quality metrics are collected by all channels and reported to PDM to be accessed by service provider and agency stakeholders (Step S108) to manage progress and ensure that high-quality data are delivered on time. Finally, the images and data archives from the census are delivered for preservation (Step S109). Throughout the process, the status of questionnaires and the associated households is reported to EDM. This begins with the printing of the questionnaires by the printing segment, and continues with delivery by the postal service provider. It also includes tasking and status of the field force through the field support segment and tracking the processing of returned questionnaires through any of the data capture segments.

It will be appreciated that the use of separate segments for each response channel may help to optimize each channel and to take advantage of the unique capabilities of that response mode to help ensure high response rates and increase quality of the data captured. Enterprise integration elements of EDM and PDM are designed to be substantially response channel-independent to allow aggregated processing of multiple responses across channels and to increase flexibility of data analysis and delivery. PDM also includes business intelligence tools to provide the flexible reporting needed by stakeholders to give them access to the right information to identify and resolve processing issues.

The delivery and data capture phase generally will the point at which the solution experiences its highest load. Peak responses on all channels occur around census day. To address this risk in a cost effective way, the high volume segments—paper and Internet—may be built with a cluster architecture. These segments may be subdivided into independent processing strings or clusters, each capable of processing a subset of the load independent of other clusters. The independent nature of these clusters allows a cluster to be tested for both function and capacity and then replicated to linearly scale the segment to the loads required for the census. By properly defining these clusters, the capacity of a cluster can be verified and the performance risk mitigated early in the development cycle.

Flexibility and consistency of the data collection concerns also arise during the data capture and delivery phase. With the paper, Internet, and telephone response modes available to the public and the political and social visibility of the census, changes may happen, and the design of certain example embodiments may help ensure that they happen consistently. To accomplish this, a data-driven approach to response processing may be implemented. This approach may be is based on a common response metadata definition that represents all relevant attributes of responses. This includes factors such as, for example, field type, length, edit rules, skip patterns, output formats, etc. The common data definition is used to drive Internet, telephone, and paper processing providing a single definition used by all channels. This approach reduces the cost and time of adapting to late changes in response definitions and eliminates “modal difference” constancy issues across response channels.

1.3.3 Example Non-Response Follow-Up

During the capture process, questionnaires may be analyzed to determine if they are blank or incomplete and, if blank, questionnaires may be “unregistered” (e.g., marked as un-received). A predefined time after census day (e.g., 10 days after census day), the field force management system may generate the list of non-responding households through analysis of the address management and questionnaire tracking databases and, once assigned, may dispatch the non-response follow-up tasks to the enumerator mobile devices. The return of questionnaires may follow the same process as data capture. Incomplete (e.g., partial response) questionnaires may be addressed through the telephone channel using outbound calling to efficiently resolve any issues.

In addition to non-response follow-up, the system may identify partial responses where required fields are incomplete. These may be identified automatically to the contact center operatives who may phone the respondent to obtain the missing information that may then be entered into EDM.

Alternatively, non-response follow-up may remain local to the field force team and may not be directed by the operational intelligence and field force management systems. In this case, respondents who choose to complete the paper questionnaire may post their completed questionnaires back to the local field force.

1.3.4 Example Post-Census Surveys

Post-census surveys may be supported in a similar manner to the census of population survey. This includes printing the survey questionnaires by the printing segment and distributing them. It also optionally includes directing the field force to conduct the survey through the use of suitable mobile devices and the field support segment. Responses may be returned through the paper segment only.

### 2. Introduction to Example Data Capture Techniques

2.1 Overview of Data Capture Techniques

The census data capture aspect of certain example embodiments may incorporate an enterprise data modeling approach combined with centralized databases to provide adaptability to changes in business rules and to standardize the processing of respondent data from all channels.

2.1.1 Example Address Register Database

An Address Register Database may hold the processing status of each household, uniquely identified by census ID, and also may enable substantially continuous reporting of non-responses to facilitate efficient use of field staff. Update of the Address Register data occurs when the response has an activity of interest (e.g., checked-in, scanned, capture completed, check-in reversed, etc.). The approach replicates the Address Register database for each channel, so status is available substantially independently of EDM, allowing critical channel data capture to continue when failures occur elsewhere.

2.1.2 Example Response Database

The Response Database may include response, coded, and quality control data from all channels, in a standardized format, with version and capture method identified for each field. Channel initiated processes may integrate captured response data into the Response Database. The Response Database may make it possible to identify duplicate census IDs when introduced, and generate follow-up cases. The Response Database also may allow the application of other edits, such as household counts and data validations and supports the delivery of data.

2.2 Introduction to Example Internet Data Capture Techniques

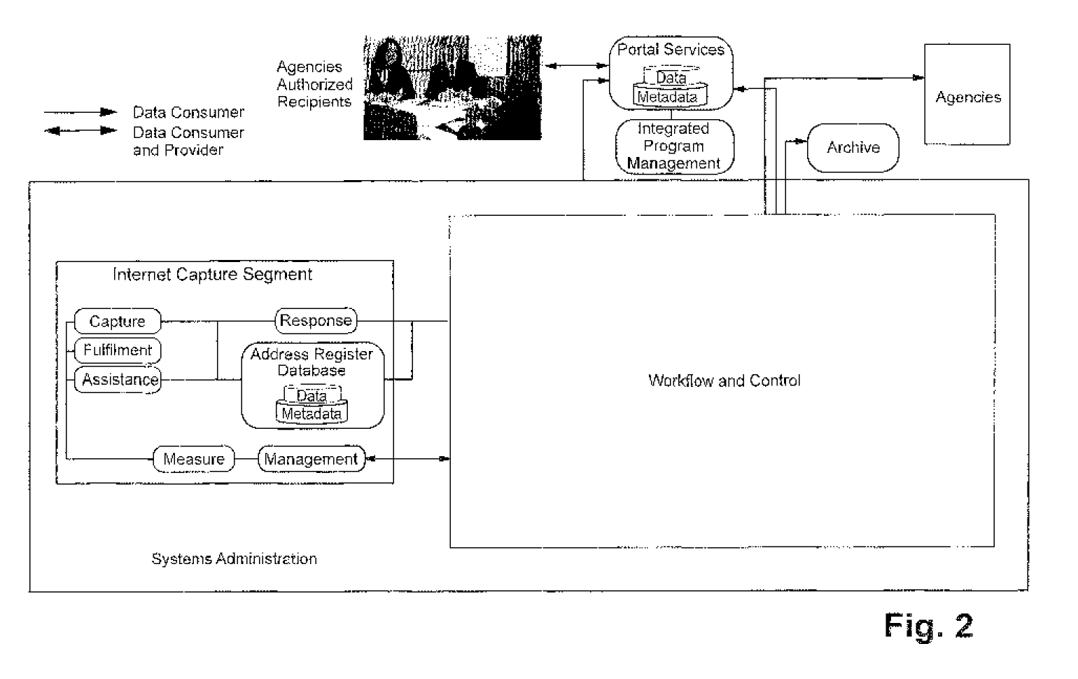

FIG. 2 is an example Internet data capture channel in accordance with an example embodiment. The example Internet data capture channel of FIG. 2 authenticates users, receives responses, records their receipt to operational intelligence, manages the capture of data from these responses, and reports management information data with date timestamps for management processing.

2.2.1 Core Internet Data Capture Solution

The basic model for storing respondent information within the Enterprise Data Management (EDM) segment are two databases—namely, the Address Register database, which contains all of the addresses used by the agencies and the associated questionnaire identifiers, and the Response Database, which is used to capture the respondent questionnaire information. The Address Register database is structured to support one-to-many relationships. Thus, each address may be associated with one or many questionnaire identifiers representing a household address with a household and individual questionnaires or a communal establishment with individual questionnaires. Each record within the Response Database has a unique identifier which is the questionnaire identifier. This creates an association with address and respondent information that can easily be produced for reporting. Individual respondent data can be listed for each household address because of the linked questionnaire identifier.

All submissions via the Internet data capture channel may have a unique Internet identifier number or Internet access code for authentication. Each Internet identifier may be associated with a unique questionnaire identifier, which is associated with an address. Upon entering this character identifier, if there is a match with the Address Register database, respondents are shown the corresponding address and asked to confirm. If there is a failed attempt to authenticate to using the Internet data capture channel, the questionnaire identifier is flagged for a failed attempt. This information can be used to track potential malicious attacks or errors in attempting to authenticate to the Internet data capture channel.

The Address Register database captures the method the questionnaire response is received and the date and time a response is started and the date and time the questionnaire is submitted. This stamp provides a means for auditing and allows for the generation of reports based on the submission time.

There may be a list of pre-generated receipt numbers that is used by the Internet data capture channel. These receipt numbers are linked to each individual questionnaire identifier and are only used if the questionnaire is completed via the Internet. Respondents receive the receipt number as confirmation their form has been received by the data capture system and the receipt number is noted in the operational intelligence.

2.2.2 Internet Reminders and Forced Submission

Some respondents may start filling out a questionnaire on the Internet, but fail to complete and submit it. These situations may cause reminder processing and possibly forced submission. The forced submission process may be based on a series of dates. For example, when a first date is reached, the operational intelligence may provide a list of questionnaire IDs to the Internet channel, which may then generate reminder emails and send to the respondents requesting that they complete their Internet version of the questionnaire. At a second date (e.g., two weeks after census day), operational intelligence may provide the list of “started but not submitted” questionnaire IDs to the field for Non-Response Follow-Up. At the commencement of a third date, the forced submission may be automatically triggered, sending all started but not submitted Internet response information to EDM to be stored in the Response Database. Any Internet response that is a result of a forced submission will be flagged to reflect the forced submission. A summary report may be produced to reflect the total number of Internet submissions that are the result of forced submissions.

2.2.3 Internet Data Capture Reports

Standard and customizable reports may be generated. For example, reports may be indicative of response rates, plus rates for incomplete Internet questionnaires and Internet questionnaires by geographic region. Additionally, a report may be generated for the number of failed authentication attempts for Internet data capture. Of course, other reports also may be generated.

### 3. Example Internet Data Capture Techniques, in Detail

3.1 Conceptual Overview

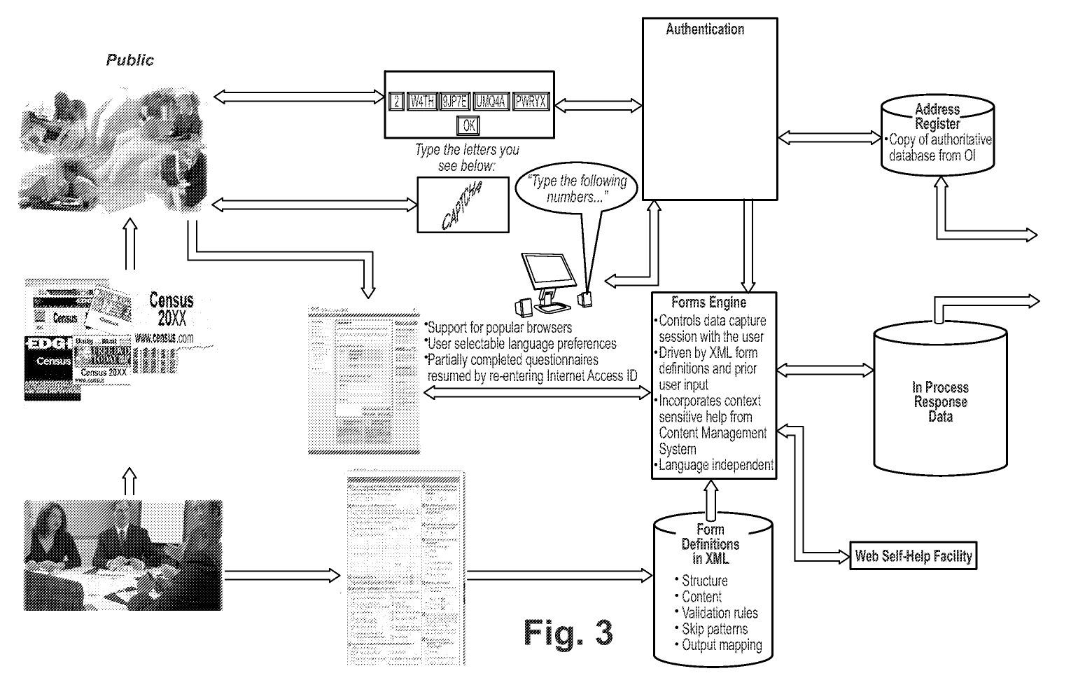

FIG. 3 shows the operational concept of an illustrative Internet data capture channel in accordance with an example embodiment. The Internet response channel provides a cost-effective means to increase the accuracy of responses, while also making it easier for the public to respond to the census. It also has the unique ability to increase the number of responses from younger generations who sometimes are under-represented in previous census activities (e.g., younger generations were under-represented in the 2001 UK Census). It is expected that an Internet website that supports 10s to 100s of thousands of pages per minute may be necessary for certain example embodiments.

Respondents may gain access to the Internet data capture service using an Internet Access ID provided with a questionnaire. The composition of the Internet Access ID may be such that guessing a valid number that is also assigned to an address is highly improbable. This help protect the public's data without requiring a password which, with millions of respondents using the Internet, would result in significant burden related to recovery from lost or forgotten passwords.

Respondents who have lost or do not have their Internet Access ID may still access the Internet data capture service and begin a new session by first passing a visual or audible test to verify that they are a person and not a computer program. The respondent may then be issued a new Internet Access ID. To protect the public from fraudulent attempts to gain access to their data, certain example embodiments may be designed such that if a respondent begins a session and loses the Internet Access ID, there is no way to regain access to the previously entered data, as there will be no way to verify that person via Internet or telephone as the one who previously entered the data.

During the authentication and completion process, it is possible that the respondent may provide a new or changed address. In such a case, the respondent may be asked to confirm the provided address, and the operational intelligence will be notified.

The data capture process includes a data driven web forms engine that uses form definition documents. In brief, these definition documents use the form specifications provided by the agencies with modal adjustments for the Internet. Form definitions also contain links to context sensitive help material and the web self-help facility, to assist the public in successfully completing their questionnaires online. Captured data and status updates are provided to operational intelligence to ensure visibility into the volumes and performance of the Internet data capture service. This approach provides the agencies with an Internet data capture service that reduces modal differences and simplifies the application of last minute changes that are common with censuses. The details of the forms engine, definition files, and other related features are described in greater detail below.

3.2 Overview of Example Internet Data Capture Service Architecture

The Internet data capture service architecture considers the needs of the public, as they are the target users who must be satisfied with the service if they are going to use and recommend it to others. It has been determined that their primary concerns are with the usability and availability of the web site and the protection of their data. Also, the agencies' staff play an important part in ensuring that the supporting facilities, systems, and processes are working properly to ensure that the public's needs are being met. To do so, they also place demands on the rest of the solution to get the visibility they need into the service and to be able to manage it effectively and efficiently.

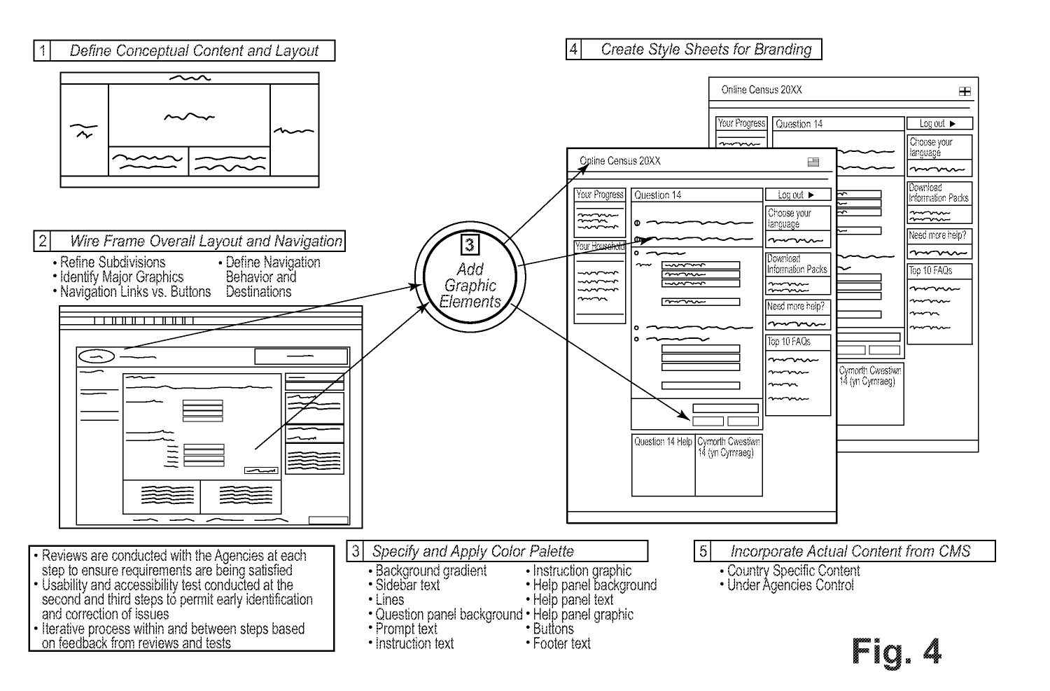

FIG. 4 is an example web user interface refinement process that may be used in connection with certain example embodiments. The web user interface refinement process of FIG. 4, with incremental reviews, testing, and iteration, help to ensure a pleasant experience for the public that includes country branding and differentiation, multiple languages, and accommodation for users with particular accessibility needs.

3.3 Robust, Scalable Architecture and Infrastructure

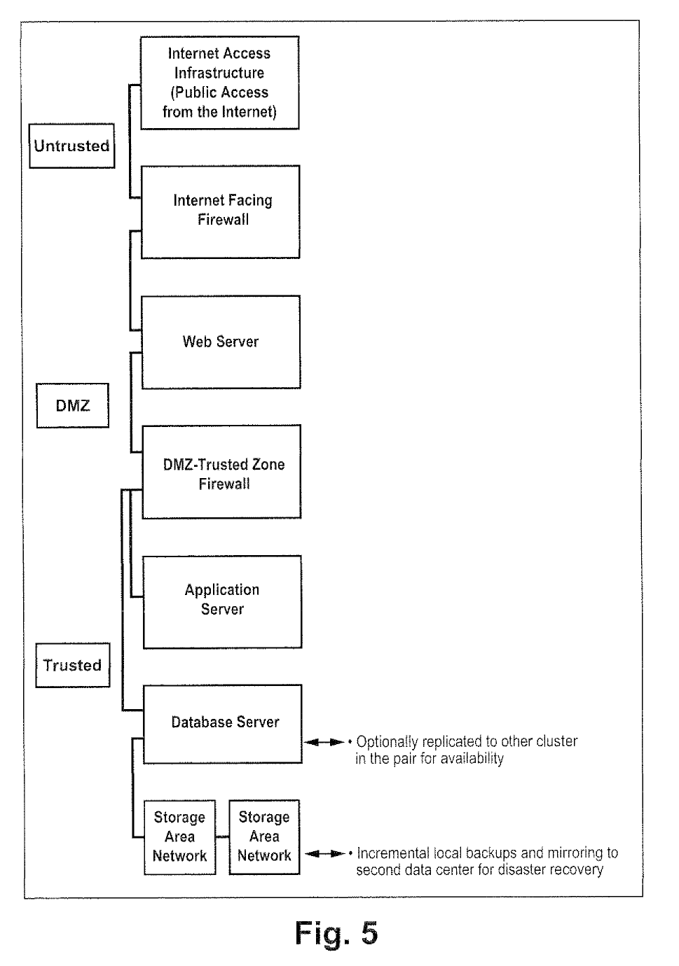

The cluster-based architecture of the Internet segment described above, one cluster of which is shown in FIG. 5, is the foundation for providing this service to the public. Security (including authentication) and scalability are some of the considerations in devising the architecture. This segment is divided vertically into three security zones, for example, following best practice guidelines for design of commercial and government websites. This arrangement help protect the website from malicious attack and helps protect the public's private data from theft or disclosure by placing multiple layers of barriers between the untrusted Internet outside of the boundary and the trusted core of the segment. It also plays a role in improving the availability of the service.

The Internet services cluster provides a scalable, secure building block that help protect the public's response and enquiry data from disclosure or loss and supports dynamic self-help functions.

Internet services clusters optionally may be deployed in accordance with an example embodiment. For example, instances of these clusters may represent the units of scalability. These clusters may be capable of providing service substantially independently of one another and the rest of the system for extended periods, thereby resulting in a unit of processing capability that can be affordably tested and subsequently scaled.

Availability is also improved as an additional benefit of the cluster architecture, as no cluster's functionality is impacted by a failure in another cluster. In addition to having a plurality of clusters (e.g., four primary clusters), a “Cluster 0” may be provided, e.g., to serve static content that is not sensitive and not attributable to an individual or household. Examples include the main and web self-help facility home pages, as well as any statically indexed FAQ or electronic publications.

To further enhance availability of service, and to protect the public and the agencies from loss of data due to equipment failure, the Internet segment may be scaled in pairs of clusters. The clusters in the pair are connected by a point-to-point network connection between their respective database servers. By doing so and exploiting advanced replication technology (e.g., provided by Oracle), each respondent's inputs are persisted into the database as they arrive and pass validation checks. The persisted data is replicated to the other cluster in near real-time so that in the unlikely event of a cluster failure. This pairing is bidirectional, meaning that each cluster in the pair actively supports over 16,000 respondents (the estimated peak day, peak hour load assuming 6.25% take-up per cluster), and their data is protected from loss without requiring redundant computing resources. The system may be configured to limit the number of concurrent users.

Knowing that the time available to capture responses from the public is limited, the Internet segment is architected to be available 24 hours a day, 7 days a week for the full duration of the defined timetable. Availability of the hardware for a pair of clusters has been calculated to be greater than 99.999%, without requiring the cost and complexity of redundant networks, firewalls, and servers within an individual cluster.

Data is maintained on independent storage area networks (SANs) for each cluster, which are configured with a large number of disks relative to the capacity requirements of the cluster to provide the disk I/O throughput required to handle the transaction loads. The SAN technology also provides automated, incremental backups of the databases to disk, which is subsequently mirrored off-site to support disaster recovery. The selected SAN solution may be database aware, ensuring that snapshots and mirrors maintain consistency, thereby helping to reduce (and even prevent) corruption of the database if necessary to restore a cluster's database from a backup.

Extensive modeling based on this configuration shows that four clusters are more than capable of handling 25% take-up of the UK population using only currently available technology. Up to about 50% take-up of the UK population is estimated to be supported using this configuration. Furthermore, scaling from 25% all the way up to 100% take-up may be accomplished in any number of ways. For example, four clusters can be built out to handle 25% take-up each. Another option starts with four clusters sized and tested to accommodate 6.25% take-up each. These clusters can then be replicated up to 16 in total to handle 100% take-up. Additional clusters can be added with relatively little notice.

3.4 Conformance to Accessibility and Usability Standards

Conformance to industry and government accessibility and usability standards may be advantageous. Because a census website represents a highly visible public face of the agencies to the people and government, it may be designed to have an attractive, appealing appearance and behave in a professional, intuitive manner that is accessible to as many people as possible.

Another factor for usability is the desire to increase Internet take-up by making Internet response easy and efficient for the public. This will help to reduce the cost to process paper returns, increase the accuracy of the captured data, and reduce the impact to the environment in the transportation of paper. Usability and accessibility are considerations in making this goal a reality, as are publicizing and promoting the website and assuring the public that their data is safe.

3.5 Information Available to the Agencies

In the event that the system is hosted at an off-agency site, or is managed by non-agency personnel, it may be advantageous to provide current status and statistics on the state and behavior of the Internet data capture system to the through operational intelligence. Such information may include, for example, the state of the Internet data capture system components and interfaces, as well as session statistics. The data in operational intelligence may be updated periodically to help ensure that at current data is available and to help provide data for trend analysis. The Internet data capture system may supply data on currently active sessions. A systems management tool may supply data on system availability and component usage (e.g., disk, RAM, CPU, etc.), and this information may be collected and reported on message queue statistics throughout the system, including the queues that the Internet data capture system uses to send response data. Web analytics support may be provided (e.g., using WebAbacus commercially available from Foviance). This tool processes web server logs to create a data store from which interactive reports and traffic visualizations are created, including historical data on session durations and response time from last byte in to first byte returned. Some or all of the following data may be logged, for example:
Requesting IP—for audit
Referrer—for “who's linking to us?” statistics
User agent for browser usage statistics
Time to serve request—for performance
Time of request
Cookies—for session monitoring
URI—for web analytics

3.6 Example Questionnaire Design

The forms engine technology of certain example embodiments (described in greater detail below) may be used to provide the core functionality to satisfy the Internet data center services requirements. In brief, this technology uses a metadata definition of a questionnaire to direct the presentation of questions, instructions, prompts, and context sensitive help. It also provides for section and page breaks, skip patterns, field edits, tick box and write in responses, and prior response references (e.g., person's actual name vs. “Person 2”). Specific style sheets may be developed and deployed (e.g., for specific countries, regions, households, etc.), e.g., to customize the appearance, consistent with branding. This is set up separately from the questionnaire definition, as the XML document that is the questionnaire definition itself only defines the questionnaire's structure and content. Basic navigational capabilities such as next, previous, and a table of contents that allow respondents to move between questions and sections are provided through the forms engine. A URI will, in turn, contain other values the analytical engine could use to provide the full richness of web analysis.

By defining questionnaires in a readily editable format, it may be possible to rapidly adapt to changes such as content, wording, and ordering. It also may be possible to create similar questionnaires by simply copying and editing the XML documents. This data driven approach makes addition of language variations, questions, and even additional questionnaires such as the customer satisfaction survey very fast and affordable. As many people decline to participate in customer satisfaction surveys, it is possible to give all respondents who complete their questionnaires the option to participate in the customer satisfaction survey to increase the amount of data available for analysis. Because this data is not associated with an Internet Access ID, respondents will not be able to stop and resume completion of the survey at a later time. This ensures anonymity and protects the data, as there may be no way for the public to access it once completed or when the session otherwise ends. This data may be handled with the same diligence as questionnaire data. Additional questions at the end of the questionnaire and additional user data such as contact phone numbers and email addresses are readily accommodated, and this data may be stored with the questionnaire data or separately as specified in the questionnaire definition. The respondent's email address is an example of data that could be stored separately and updated in operational intelligence any time the respondent changes it. Working with the agencies, it is possible to design the Internet data capture questionnaires to reduce undesirable modality differences, while accounting for the differences in user expectations and questionnaire content that come with Internet completion.

3.7 Modification, Distribution, and Saving Data on PCs

Part of securing the website ensures that page content stored on the system's servers cannot be modified from the public-facing side and takes the precaution of monitoring checksums of files to raise alerts if files should be modified without authorization. It is, however, not possible to serve content to be rendered in a user's browser and prevent it from being captured by programs that emulate browsers using HTTP or HTTPS protocols. While it is not possible to prevent content from being “modified or distributed,” it is possible to prevent modified content from being placed on the website and distributed in place of original content.

Though the forms engine design does not depend on temporarily saving data on the respondents' PCs, it is not possible to prevent respondents from capturing screen shots of their browser sessions. Instructions can be included or signposted on how to clear the browser cache for various browsers for those respondents who may have concerns about leaving personal data behind at the end of the session.

3.8 Illustrative Requirements for Example Internet Data Capture Techniques

The forms engine of certain example embodiments may be designed to reduce the requirements for respondent computers, thereby increasing the population that can use the Internet to complete their census questionnaires.

To this end, certain example embodiments may involve attempting to work with a “least common denominator” of respondent hardware and software. For example, the techniques responsible for data capture may be supportable through HTML 4 and CSS, which are common to all current browsers. Migration to XHTML 1.0 or later also is possible, although support of the standard is not universal. Alternative client-based solutions such as applets or stand-alone client/server applications also could be used, although distribution, installation, security, compatibility, and increased support issues may arise when using these alternatives rather than a straight browser-based solution.

For those respondents who encounter difficulty with particular questions, the forms engine of certain example embodiments may link to a web self-help facility at the individual question level, as well as providing for global access to topics and features. Appropriate contact center telephone numbers (e.g., for country, language, etc.) also may be included. Such a contact center may have access to the full capabilities of the web self-help facility, with augmented content as needed to facilitate assisting the public with technical difficulties they may have accessing or using the Internet data capture solution. Technical experts on the forms engine are may be available to the contact center advisors should a problem arise that is not anticipated and therefore not already documented.

3.9 Example Authentication, Presentation, and Completion Techniques

3.9.1 Example Authentication Technology

It would be advantageous to instill public trust that personal information will be kept secure and in the highest confidence through use of effective authentication mechanisms and secure protocols.

As noted above, to ensure that only authenticated users have access to the data capture service, an Internet Access ID that is similar to the CD keys commonly found with commercial software packages. The Internet Access ID may comprise approximately 20 alphanumeric characters presented in groups of 4 or 5 characters that the respondent would enter into the login screen for the data capture application and selected web self-help facility fulfillment functions. It is believed that this familiar approach to authentication will be well received by the public, particularly as the length of the ID may be limited to 20 characters rather than the 25 characters commonly in use today. The length of the ID can be adjusted, but a balance must be maintained between the usability of the ID, which argues for a shorter length, and the robustness of the ID, which argues for a longer length. In certain example implementations, it may be desirable to require an additional step of entering a house number or name and post code, given the extremely rare chances of guessing an algorithmically valid ID that is also one of the relatively few that has been allocated and stored in the OI database. There is value in having the application present the address to the respondent as a means of assuring the respondent that they have connected to the real census website, as the association between Internet Access IDs and addresses is not generally known.

The following table summarizes some of the beneficial characteristics of using an Internet Access ID format.

| Characteristic | Benefit |
|---|---|
| 37,778,931,862,957,161,709,568 | Odds of guessing one of 30 million |
| combinations, when the last | household Internet Access IDs are 1 |
| 5 characters are used as a | in 1,259,297,728,765,238 |
| check code | |
| 15 randomly generated characters | Allows basic validity of the Internet |
| with a 5 character check code | Access ID to be algorithmically |
| | checked very quickly on the server |
| | side, and reduces the need for |
| | database lockup, which defeats |
| | attempts at overloading the |
| | service by flooding it with |
| | access requests |
| 32 alphanumeric characters | Avoids potentially confusing |
| used (versus 36) | characters, eg., “0”, “O”, “1”, |
| | and “I”, as confusion may put off |
| | some respondents and result in |
| | increased calls to the contact center. |

These Internet Access IDs may be generated in advance and either associated with specific paper forms and therefore questionnaire types, or held in reserve for distribution to households or individuals who did not receive a form, received the wrong form, lost their form, or require an individual form. Because in-process respondent data may be keyed in the database to the Internet Access ID, it may not be possible for Internet users to access other users' data, even if those other users are in the same household. To protect the website, the algorithm for generation and validation of the check code is highly protected to reduce the chances of computerized generation of valid Internet Access IDs, which could be used in an attack that would degrade performance of the website by raising the bit rate on the database servers (e.g., a denial of service attack). Failed access attempts may be logged in operational intelligence with associated data to support analysis and corrective actions. Users returning to the website after being away simply log back into the website using their Internet Access ID and continue where they left off. They can do so from any suitable computer, as all data may be kept centrally in the data centers. This applies equally to users who walk away from a session and are subsequently timed out after a predetermined time interval.

The database used by the Internet data capture solution of certain example embodiments may be a copy of the operational intelligence address database that is kept up to date in near real-time with the master that is maintained within the system by operational intelligence. Successful questionnaire starts and completions may be sent to operational intelligence via a common messaging interface. Updates to operational intelligence also may be sent when sessions terminate for questionnaires in process, such as when a session times out or the respondent logs out. These updates will include the state of completeness of the questionnaire as determined through checks against criteria to be established by the agencies. When operational intelligence updates its master database, the update is replicated back to each of the Internet clusters (e.g., through Oracle Advanced Replication). This helps keep each of the Internet clusters current on address changes, Internet Access ID allocations, and completion notifications. It also reduces the chances of an Internet Access ID being reused once an Internet form is submitted, and it can be extended to apply to when an associated paper form is received. The Internet clusters locally help to ensure that only one questionnaire or session is started for each unique Internet Access ID, as well as that the questionnaire type presented is the one recorded in the database for that ID. Once questionnaires are submitted, the response data are sent to operational intelligence and, upon confirmation of receipt from OI, are deleted from the Internet cluster. Alternative authentication schemes also are possible. Also, failed access attempts may be recorded in certain example embodiments.

3.9.2 Example Presentation of Questionnaires

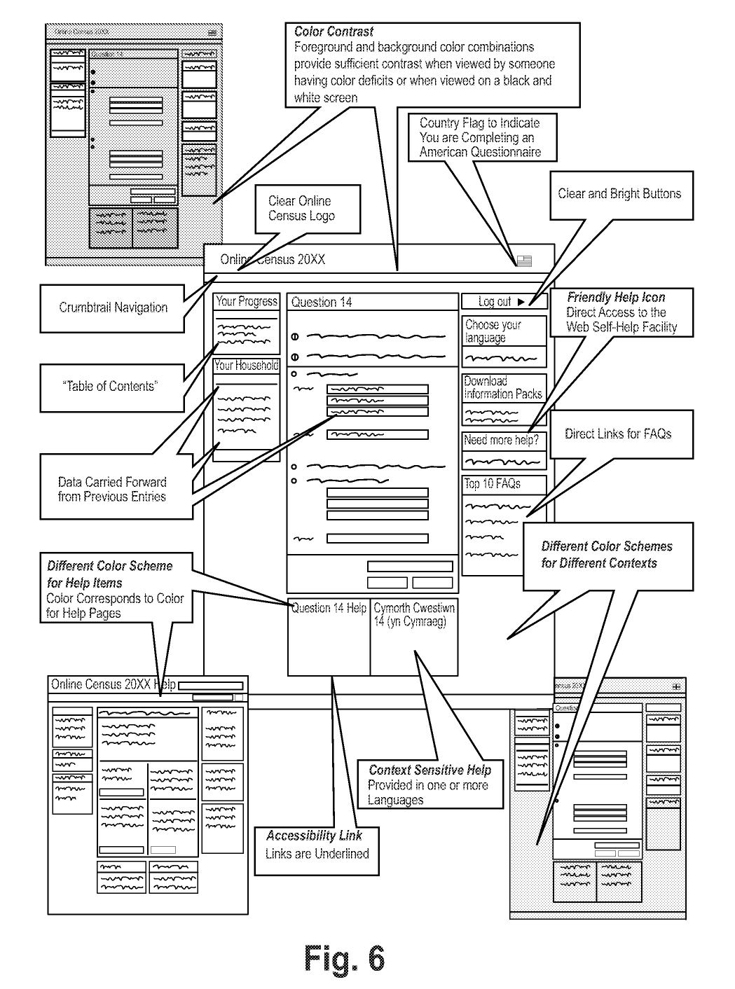

As illustrated in FIG. 6, which shows certain Internet data capture user interface design features available through certain example embodiments, an example user interface (UI) design may provide numerous features to assist respondents with completion of their questionnaires. For example, Internet Data Capture UI design features may help to focus the respondent's attention on completing the questionnaire whilst providing a wealth of helpful functions. Among the features of the UI is a table of contents sidebar that gives respondents feedback on their progress in completing the form and allows them to quickly navigate back to previously completed questions. If changes are made to previously entered data, we skip pattern checks may be reapplied to remove data that no longer applies or present the user with questions that now apply. Similarly, people who are added to or deleted from the household will have their questions presented for entry or their data removed, respectively. While there are potential benefits of not deleting data for household members who have been removed from the roster until submission, there also is potential for confusion if people are added back, potentially in a different position or with a slightly different spelling. Previously entered data that is rendered not applicable as a result of changes to an answer that trigger a skip pattern (e.g., changing an age to <16 after previously entering industry and occupation details) may be preserved in certain example embodiments, as other changes may be made that effectively mean the person in question has been changed. The sidebar can also be used as an area in which to indicate when and where questions have been skipped and allow users to determine what rules triggered the skip. The forms engine of certain example embodiments also allows for the response information to be carried forward, such as the name of a second person in the household, to personalize the presentation of their questions, or to present questions that relate to them later in the questionnaire using their name instead of a placeholder. The forms engine of certain example embodiments may or may not place limits on the number of people who can be specified for a household.

As the respondent completes the questionnaire, validation and edit checks may be performed for each question. These checks may be specified in the definition of the questionnaire and may include such checks as, for example, dates, numeric ranges, single versus multiple selections, etc. Instructions and context-sensitive help will provide guidance to the respondents. For example, if a respondent makes an error, a message may be displayed. Depending on the language options supported for each country, context sensitive help can be presented in the respondent's primary and, if desired, secondary choice of available languages.

3.9.3 Example Additional Language Support

One benefit of the forms engine of certain example embodiments is its ability to be adapted quickly to other languages (e.g., a UK survey may be presented in Welsh, Scottish Gaelic, Irish, Ulster Scots, etc.). Because the text of all questions, prompts, and instructions may be contained in the XML document that defines the form (as described in greater detail below), providing text in another language simply may be a matter of editing the document to replace the text with that of another language. XML documents in general and the form definitions of certain example embodiments can contain multi-byte characters including, for example, those characters unique to the Welsh language. Alternatively, these characters can be inserted into the textual content of a form definition using their HTML character codes such as &4372 for “Ŵ.” User input of the two Welsh-specific characters “Ŵ” and “Ŷ” and their lower case equivalents from the keyboard in conjunction with the AltGr+6, Shift W (or Y) key sequence is dependent upon users having the appropriate service packs installed in the case of Microsoft operating systems or using the Character Map program to copy them to the clipboard and paste them into the browser. The database and response data messaging formats of certain example embodiments use UTF-8 encoding of characters internally, which preserves these characters in two bytes without increasing the storage size for other characters. The characters will be shown on the synthesized electronic images as they were input by the respondent. Context sensitive help, which is subject to a higher rate of change than the questionnaires themselves, may be maintained separately, thus allowing it to be updated dynamically and in concert with other language content once changes are approved.

3.10 Example Questionnaire Submission

The Internet data capture service of certain example embodiments may allow the public to complete their questionnaires over multiple sessions. Additionally, deadlines may be imposed for completing some or all of the questionnaire.

More generally, it will be appreciated that the submission process may be controlled to varying degrees in certain example embodiments. For example, specific parameters, conditions, and/or inputs may be defined and used to control the automatic, forced submission of questionnaires. Respondents may be notified of the relevant due dates to give them the greatest opportunity to complete their questionnaires. After a set date, for example, the internet data capture service of certain example embodiments may no longer accept logins for Internet Access IDs, e.g., as an absolute matter or unless they are for “in process” questionnaires. After the shutdown date for IDC, all remaining Internet Access IDs may be disabled.

Questionnaires may be checked for completeness when respondents attempt to submit them. If questions have not been completed, the respondent may be given the option of being directed to the missing portions of the questionnaire. However, submitting the questionnaire may be disabled if core questions have not been answered. Additionally, through the definition of the questionnaire for the form engine of certain example embodiments, it may be possible to require answers to specific questions before proceeding to subsequent questions. Submissions that have been forced may be flagged as such to operational intelligence, to allow them to be tracked and for statistics to be collected.

Internet Access ID and questionnaire response data passed on to operational intelligence may be the same whether a submission is user-directed or forced. In both cases, date, time and the submission flag (user entered or forced response) may be passed to operational intelligence, along with the questionnaire data. A receipt number may be provided when respondents submit their questionnaires as proof of submission, advising that the respondents should retain the receipt number as proof of compliance. This number may be kept in operational intelligence to support verification by field personnel who may be following up on the questionnaire. An email confirmation of submission also may be provided, and it may include the receipt number, whether the submission is user directed or forced, etc., if the respondent provides an email address for that purpose. Once submission is confirmed by operational intelligence, the questionnaire may be marked as completed and the Internet Access ID disabled, so as to disable further access to or modification of the questionnaire by the respondent. The same status update may be made when a paper questionnaire is receipted, thereby permitting the disabling of the Internet Access ID associated with the paper.

A digital image of submitted electronic questionnaires from the Internet may be created (directly or through the contact center) in a format, and multiple images may be grouped together.

3.11 Security

Confidentiality of the public's census data is desirable, and the systems of certain example embodiments may provide one or more layers of protection to reduce the chances of unintended disclosures. In certain example embodiments, multiple security techniques may protect the data and/or the service itself.

Access to questionnaire data may be keyed to the Internet Access ID used to create it. This help keep the respondent's data secure prior to submission, e.g., by attempting to restrict access to the respondent's data to the respondent who, advantageously, is the only person who knows the ID and who carries the responsibility to protect it while it is in use, just as with any other user id and/or password the respondent may possess. The formulation of the Internet Access ID is such that it is extremely difficult to guess an algorithmically valid ID and even harder to guess one that is actually associated with a particular household or individual. This design also helps protect against fraudulent submissions and malicious behavior. In certain example situations, users who do not have an Internet Access ID may be provided with a with a Completely Automated Public Turing test to tell Computers and Humans Apart (CAPTCHA) to solve. These situations may include, for example:
The respondent wants to fill out an individual questionnaire and needs an Internet Access ID for that purpose.
The respondent wants to request a replacement for a lost or undelivered questionnaire or other printed materials to be posted to them.
The respondent wants to request that an enumerator come around to assist them.

CAPTCHA is a technique used by commercial websites, online polling, and free email service providers to reduce the likelihood of computerized bots commonly used by spammers from automatically signing up for massive numbers of accounts. CAPTCHAs sometimes take the form of distorted text on color gradient backgrounds that can be readily interpreted by humans but are beyond the abilities of conventional OCR technology. Visually impaired users can be accommodated by audio-based techniques such as spoken numbers with a somewhat noisy background that people can understand, but are resistant to speech recognition technology. These techniques may be employed only when respondents do not have an Internet Access ID. In conjunction with audit trails of accesses to questionnaire data by the public or the system and enforcing reasonable limits on the number of written material requests per Internet Access ID, these techniques are expected to reduce malicious or mischievous behaviors and fraudulent submissions. Audit trails may be provided on a schedule. Sustained attacks on the system may be quickly noted and reported. Of course, it will be appreciated than any suitable authentication mechanism based on, including, or apart from, those presented herein may be used in connection with certain example embodiments.

The forms engine of certain example embodiments does not depend on keeping submission data on respondents' computers. Instead, all census data may be maintained in a database behind layers of firewalls and intrusion detection and prevention systems. The data capture application also may be accessible only through secure (e.g., HTTPS) encrypted protocols that provide bidirectional protection of RESTRICTED data while in transit between the respondent's browser and the data capture system. Additional messages advising the public about precautions it should take to protect its data may be displayed.

Backup of data in the Internet clusters may take on multiple forms. For example, Oracle Advanced Replication may be used to copy data from one cluster in a pair to the other, providing protection from loss of access to the services of a cluster. The SAN may perform periodic, incremental snapshots to protect from corruption or accidental deletion of database records. The SAN also may perform data center to data center mirroring of the snapshot storage to protect from catastrophic loss of a data center.

### 4. Introduction to Example Template-Driven Internet-Based Information Capture Techniques

Certain example embodiments include programmed logic circuitry (e.g., any suitable combination of hardware, software, firmware, and/or the like) that is configured to dynamically generate a computer-accessible (e.g., web-based) survey from one or more definition files. The survey may be defined in a response definition file and a user interface definition file. The programmed logic circuitry reads the definition files and presents the survey to a respondent or user, applying the appropriate validations and transformations specified in the definition file. In certain example embodiments, the survey may be made available through the Internet or other computer interface and, thus, the programmed logic circuitry may be implemented as webpage software.

Typically, web surveys are implemented as custom web applications that are specifically designed for the details of the survey in an enterprise integration architecture. By contrast, certain example embodiments may be implemented using a Reusable Web Architecture (RWA). In such a case, each survey may have its own definition files that separately specify (1) response characteristics and (2) user interface characteristics. A common program engine may then provide interpretation of the files and respondent or user interaction.

This arrangement is advantageous, as it typically is easier to simply define a form, rather than having to define the form and also write code to implement it. As such, survey development, testing, and maintenance costs, as well as time to market may be reduced. In addition, the characteristics of the survey may be changed easily, e.g., by changing the definition files. This feature, in turn, helps make the implementation more flexible than custom designed web applications. Accordingly, certain example embodiments advantageously may provide an inexpensive, flexible, and reusable web-based survey. The engine responsible for implementing the web-based survey may be developed only once, thus providing a “deep and durable” solution. That is, multiple custom surveys and/or multiple versions of a single survey may be generated in as they are needed, thereby providing an inexpensive and disposable survey that can be developed and implemented quickly and easily. Certain example embodiments thus may be advantageous in that time-to-market can be reduced, e.g., when updates are necessary, thereby saving substantial costs. This may be facilitated by allowing common metadata to be supported across all response channels.

As alluded to above, certain example embodiments relate to an architecture that reads survey definition files, displays and runs an interactive survey, and stores survey results. Such example embodiments may be operationally thought of as including some or all of the following steps:
Defining the survey
Defining the look and feel of a user interface (which may be implemented in certain example embodiments using cascading style sheets or CSS, for example)
Defining survey form questions, rules, and verbiage (which may be implemented in certain example embodiments using one or more XML schemas, for example)
Providing a forms engine (e.g., to process the predefined CSS and the one or more predefined XML schemas that respectively comprise the user interface and the survey definition)
Enabling modular authentication (e.g., so that respondents or users completing the survey can be recognized one or more times)
Reading the appropriate survey definition files (e.g., the predefined CSS and one or more predefined XML schemas, which may depend on the respondent or user authentication)
Generating and presenting the survey to the respondent or user (e.g., via the forms engine)
Applying specified validations and transformations (e.g., in dependence on the respondent or user authentication)
Skipping unnecessary questions (e.g., in accordance with respondent or user responses and in dependence on forms engine processing of the one or more predefined XML schemas)
Persisting results between sessions (e.g., by storing results, at least temporarily, in a database)
Outputting a completed response (e.g., in accordance with an XML schema)

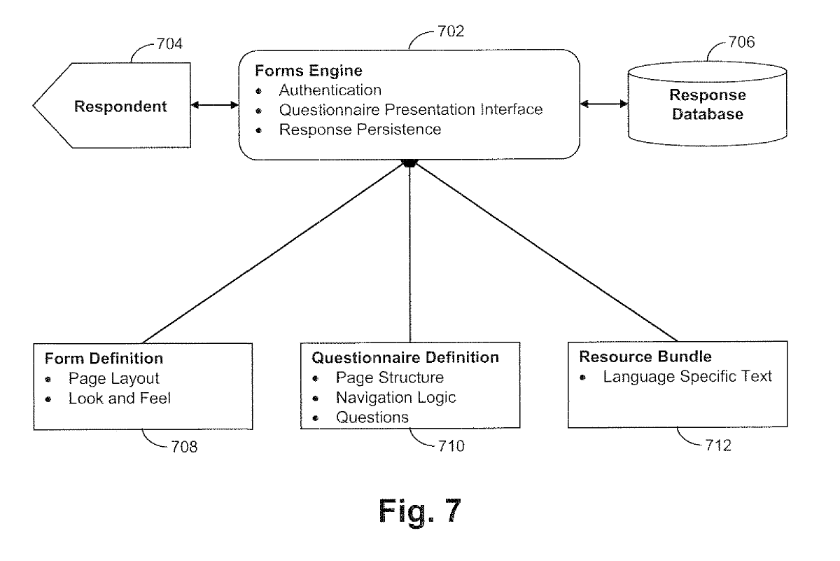

In view of this operational example, FIG. 7 is an illustrative, high-level context diagram in accordance with certain example embodiments. In FIG. 7, a forms engine 702 helps provide authentication functionality, e.g., so that the user or respondent 704 can be recognized and/or authenticated. The forms engine 702 also provides the questionnaire presentation interface for the user or respondent 704. That is, the forms engine 702 presents questions to the user or respondent 704 and also accepts answers from the user or respondent 704. The forms engine 702 may present information according to a form definition 708. The form definition 708 may include instructions indicating, for example, the particular page layout, the look-and-feel of the user interface, etc. The type of information presented by the forms engine 702 may be in accordance with a questionnaire definition 710. The questionnaire definition 710 may be indicative of the page structure, navigation logic, and actual questions to be asked. The forms engine 702 may present information in dependence on one or more resource bundles 712. For example, a resource bundle 712 may language specific text, e.g., for the overall page layout, specific questions, etc. The forms engine 702 may persist responses using a response database 706. Responses may be persisted in such a response database 706 between sessions of a single user or respondent 704, and/or for all users or respondents 704 completing the survey.

### 5. Example Architecture and Design for Template-Driven Internet-Based Information Capture Techniques

5.1 Overview of Template-Driven Internet-Based Information Capture Techniques

Certain example embodiments may be designed to capture user responses from structured web interviews. The web interviews may be defined in one or more definition files or templates. A template may be read by an interview session driver or forms engine. The interview session driver or forms engine then presents questions to the users and captures responses. The template may include, for example, an abstract notion of information to be captured, context sensitive help, internationalization, navigation, presentation, and/or business rules. The interview session driver may be implemented as any suitable combination of programmed logic circuitry (e.g., any suitable combination of hardware, software, firmware, and/or the like) that supports modular authentication, personalized template retrieval, interview presentation, navigation, information capture, and business rules enforcement, as well as response persistence. For example, the interview session driver may be a J2EE application in certain example embodiments. The architecture may be modular, secure, scalable, reliable, inexpensive, and open. The template may support common interview question types and business rules. The template also may support internationalization and presentation look and feel. The template may be substantially fully extensible, e.g., so as to accommodate future requirements without structural rework.

As such, a generic information capture application may insulate the questions to be asked horn the application that asks the questions. This application may be designed to be durable and to reduce the amount of alteration required to support a plurality of interviews. Accordingly, certain example embodiments provide this abstraction of interview definition from web application realization, as well as an architecture that is used to both define and drive an information capture session.

In certain example embodiments, this application is not bespoke. Conventional Internet application development involves changing corresponding code when a change is made to a web form. This change has direct and hidden costs including, for example, developer time, testing time, overhead, etc. In contrast, the system of certain example embodiments enables a template to be changed substantially independent of the underlying code, thereby reducing (and sometimes even eliminating) many costs.

The interview session driver may be built on a reliable, scalable, secure, open architecture in certain example embodiments. Given that this system is designed to capture information from Internet users or respondents, the system may be scalable to handle an enormous volume of users or respondents. With an environment including ever-mounting security concerns, the system must be secure, so as to protect user identity and information. The Internet is “always on,” so the use of reliable system components is advantageous. These considerations inform the choice of which platform to use and where to store templates (e.g., a J2EE platform may be used with templates stored in the operating system). By way of contrast, some prior art solutions store form definitions in a database, which can lead to reliability, scalability, and cost concerns. Additionally, some prior art solutions are based on closed, proprietary architectures that are less secure, reliable, and scalable, while also being more costly.

In certain example embodiments the template may be built based on separate configuration files. For example, if may comprise XML and CSS files. The choice of XML for the interview session definition advantageously leads to simplicity of change, as well as flexibility in the definition of rules. Other prior art approaches use databases to persist form definitions, which can be constraining as every combination of rules, constraints, context, etc., generally must be captured in a database schema. Such prior art systems may lead to constraints in data types and options, and also generally has higher costs associated with maintenance and evolution.

The template of certain example embodiments may support a rich array of question and answer types, prompts, constraints, skip patterns, contextual verification, and/or the like. Examples of answer types include, for example: choose one, choose many, fill in the blank, etc. Constraints include, for example: required field, required based on context, answer conflicts with prior response, and the like. Skip patterns allow questions to be added or subtracted based on prior answers. Other prior art approaches support questions and answers and some limited constraints. However, there is no known existing solution that supports contextual constraints or skip patterns.

The form template may be fully internationalized in certain example embodiments, thereby allowing users or respondents to switch languages at any point in their session. This, in turn, may enable the entire form to be re-rendered with prompts, help, navigation, etc., as well as the form layout and look and feel to be adjusted accordingly. Industry standard internationalization implies creating a second application in a second language and forcing the user to choose a language at the start of the information capture session. The prior art does not address internationalization and is assumed to follow industry standards, if internationalization is supported at all.

5.2 Example Architectural Features

Certain example embodiments may be capable of supporting a number of functional and non-functional architectural features. This may include some or all of the following example functional features:
F1: Basing display on form definition file (e.g., no code change to update structure or content of a questionnaire)
F2: Storing results in a database after every response
F3: Allowing storage of a response or multiple responses for later completion
F4: Having context-sensitive help
F5: Supporting left-to-right multi-byte character sets
F6: Having the ability to show previously entered data in a prompt for later questions or section titles
F7: Supporting selection group question types (e.g., multiple tick boxes or radio buttons specified either explicitly or implicitly, e.g., based upon a max selections specification)
F8: Supporting write-in question types
F9: Supporting multiple sections per questionnaire (e.g., general household information, Person X, summary, etc.)
F10: Supporting field constraints such as, for example, length, optional vs. mandatory, min/max ticks per selection group or question, etc.
F11: Supporting the use of style sheets for all types of elements
F12: Supporting numeric range, date, postcode syntax, email address, telephone number, etc., field validation
F13: Having a table of contents sidebar
F14: Having “go-to” ability (e.g., in a table of contents sidebar)
F15: Indicating progress (e.g., via a table of contents)
F16: Separating context-sensitive help from the form definition file
F17: Supporting the repeating of sections (e.g., Person X, where the Person section is specified once, but repeated for as many people as are input in the household roster in the general household information section, etc.)
F18: Supporting Skip Spec (including compound conditionals . . . AND, OR)
F19: Applying Skip Specs whether moving forward or backward through the questionnaire
F20: Presenting skipped question(s) when a respondent goes back and changes a condition to negate a skip
F21: Supporting user-oriented error messages in the user's selected language when field validation/constraint checks fail
F22: Providing a receipt number/code when submitted
F23: Supporting formatting within instructions and prompts (e.g., bold, italics, bullets, etc.)
F24: Deleting any prior response(s) for skipped question(s) when a respondent goes back and changes condition that trigger a skip
F25: Allowing a user to choose a language at any time
F26: Enabling a context-sensitive help to be shown in up to two languages simultaneously
F27: Allowing different authentication mechanisms, e.g., via a modular login mechanism
F28: Defaulting the Selection Group question presentation style to be multiple tick boxes or radio buttons based upon the max_selections specification if no explicit presentation style specified
F29: Disallowing access once submitted

Additionally, some or all of the following example non-functional features may be supported:
NF1: Providing portable Java code
NF2: Reducing the number of end-user computer dependencies (e.g., by using simplified HTML while avoiding coding that might require add-ins such as, for example, Flash animations, applets, etc.)
NF3: Avoiding the persistance of cookies
NF4: Allowing users to access their own form only

5.3 Example Use Case Diagram

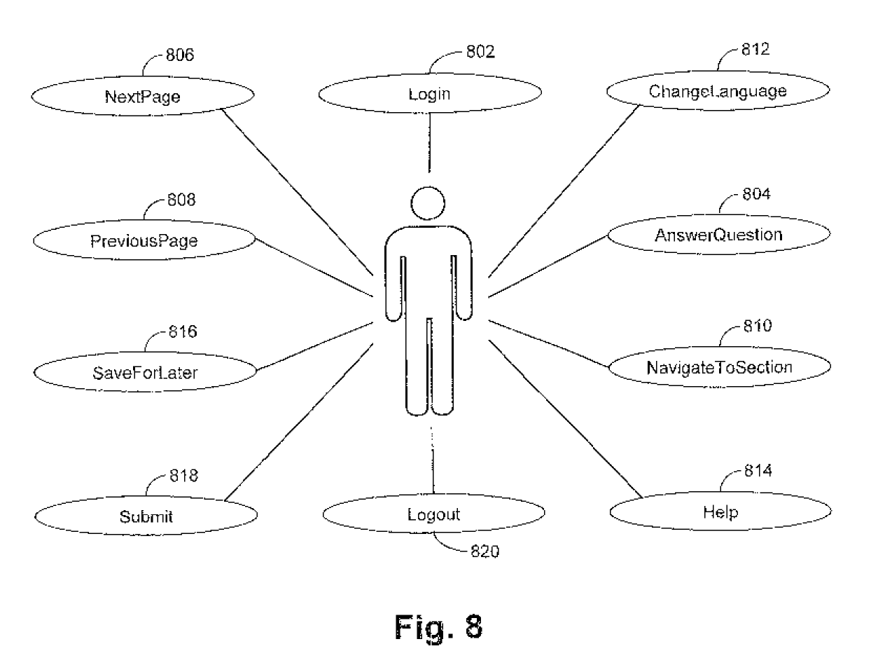

FIG. 8 is an illustrative use case diagram in accordance with certain example embodiments. A user may login to the system via a login use case 802, thus implicating architectural features F27, F29, and NF4, for example. A user may accept a questionnaire answer via an answer question use case 804, thus implicating architectural features F2, F10, and F12, for example. A user may go to the next questionnaire page via a next page use case 806, thus implicating architectural features F1 and F6, for example. A user may go to previous questionnaire page via a previous page use case 808, thus implicating architectural features F1, F6, F7, F8, F9, F11, F17, F18, F19, F20, F23, F24, and F28, for example. A user may jump to a questionnaire page via a navigate to section use case 810, thus implicating architectural features F13, F14, and F15, for example. A user may change questionnaire language via a change language use case 812, thus implicating architectural features F5, F21, and F25, for example. A user may get help via a help use case 814, thus implicating architectural features F4, F16, and F26, for example. A user may save the questionnaire responses via a save for later use case 816, thus implicating architectural feature F3, for example. A user may submit questionnaire responses via a submit use case 818, thus implicating architectural feature F22, for example. A user may logout of the system via a logout use case 820, thus implicating architectural feature F27, for example.

5.4 Example Architecture

5.4.1 Overview

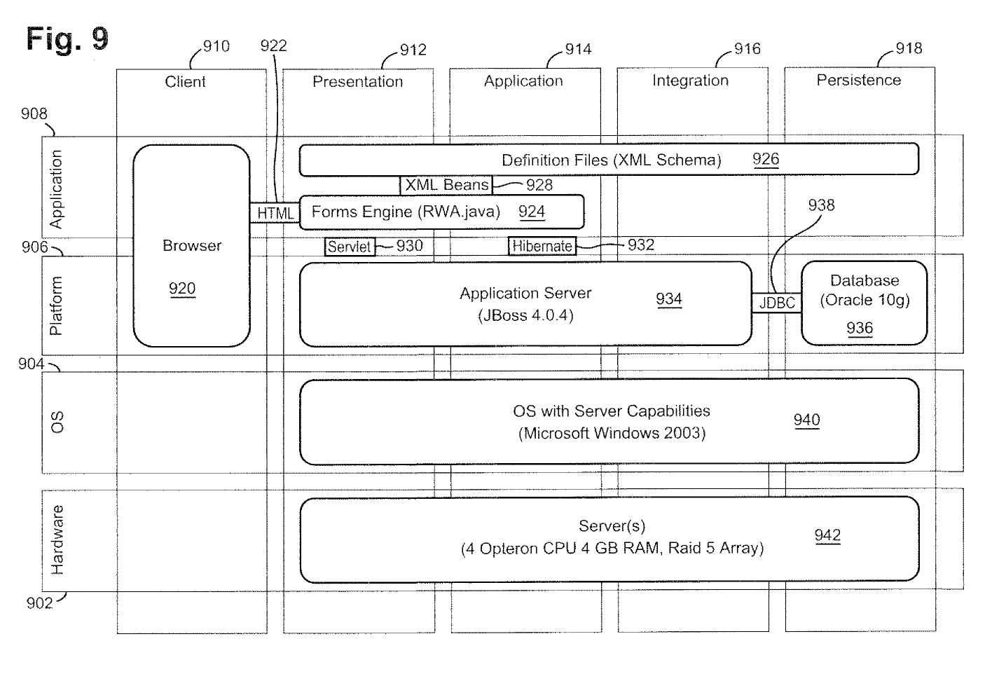

FIG. 9 is an example architecture stack in accordance with an example embodiment. More particularly, FIG. 9 shows the hardware 902, operating system 904, platform 906, and application 908 layers of the architecture that support client 910, presentation 912, application 914, integration 916, and persistence 918 implementations. A browser 920 for the client 910 sits on the platform and application layers 906 and 908. The browser 920 uses an interface 922 (e.g., an HTML interface) to connect with the forms engine 924, which may be implemented in the presentation and application implementations 912 and 914 (e.g., as a JAVA application). As noted above, the forms engine 924 may operate in dependence on definition files 926 (which may be developed according to one or more XML schemas, for example). The forms engine 924 and the definition files 926 are implemented in the application layer 908. However, although the forms engine 924 may be implemented in the presentation and application implementations 912 and 914, the definition files 926 may be implemented across the presentation 912, application 914, integration 916, and persistence 918 implementations. The forms engine 924 may access the definition files 928 via an interface 928 that sits in the application layer 908 but exists across the presentation and application implementations 912 and 914. When the forms engine 924 is implemented as a JAVA application and when the definition files 926 are implemented as one or more XML schemas, XML Beans may be used in this regard.

Although not shown, a Virtual Machine may be provided for facilitating the execution of at least the forms engine 924. For example, when a JAVA implementation is chosen, a JAVA Virtual Machine may be implemented (e.g., the JDK 1.5.0.6). Any acceptable Servlet engine may be used in certain example embodiments including, for example, Servlet engines that support JDK 1.5 and J2EE 1.4 Servlets (e.g., Tomcat, JBoss, Weblogic, etc.).

In this regard, middleware may be provided between the platform and application layers 906 and 908. For example, Servlet middleware 930 and Hibernate middleware 932 respectively may be provided in the presentation and application implementations 912 and 914, so as to provide functionality between the application server 934 located in the platform layer 906 and the tools running in the application layer 908. In certain example embodiments, the application server 934 may be implemented using JBoss 4.0.4. The forms engine 924 may build a file deployed into the application server 934 (e.g., a ReusableWeb JAVA project may build a war file that is deployed into the JBoss application server). A database 936 (e.g., an Oracle 10 g database) may be provided in the platform layer 906 for persistence 918. The application server 934 may interface with the database 936 using any suitable database client 938 (e.g., JDBC).

In the OS layer 904, an operating system 940 may be deployed across all implementations except for the client implementation 910. The operating system 940 may have server capabilities (e.g., the Microsoft Windows 2003 operating system). Similarly, in the hardware layer 902, one or more servers 942 may be deployed across all implementations except for the client implementation 910. By way of example, a server may be provided that includes 4 Opteron CPUs and 4 GB of RAM. Such an example server may be attached to a Raid 5 storage array. It will be appreciated that the client implementation 910 is not dependent on any particular OS layer 904 or any particular hardware 902. Quite the contrary, any suitable hardware and/or OS may be used in connection with certain example embodiments so as to allow a wide variety of different users or respondents to access the system. In general, then, any suitable hardware and/or OS capable of running a browser 920 may be used in connection with certain example embodiments.

In view of the above, it will be appreciated that the underlying forms engine and other components may not be detectable via visual inspection or product operation. In other words, the underlying programmed logic circuitry may be transparent.

It will be appreciated that the above-described architecture is provided by way of example and without limitation. For example, the various components may be varied in terms of the layers in which they are implemented, the hardware and/or software with which they are implemented, and/or the particular implementations in which they are located.

5.4.2 Example Form Schemas

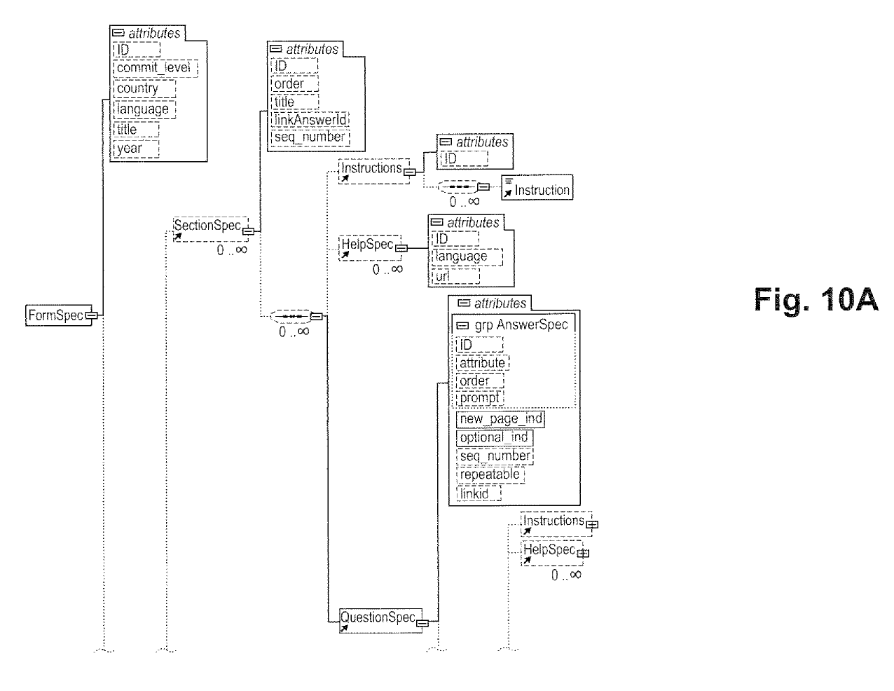

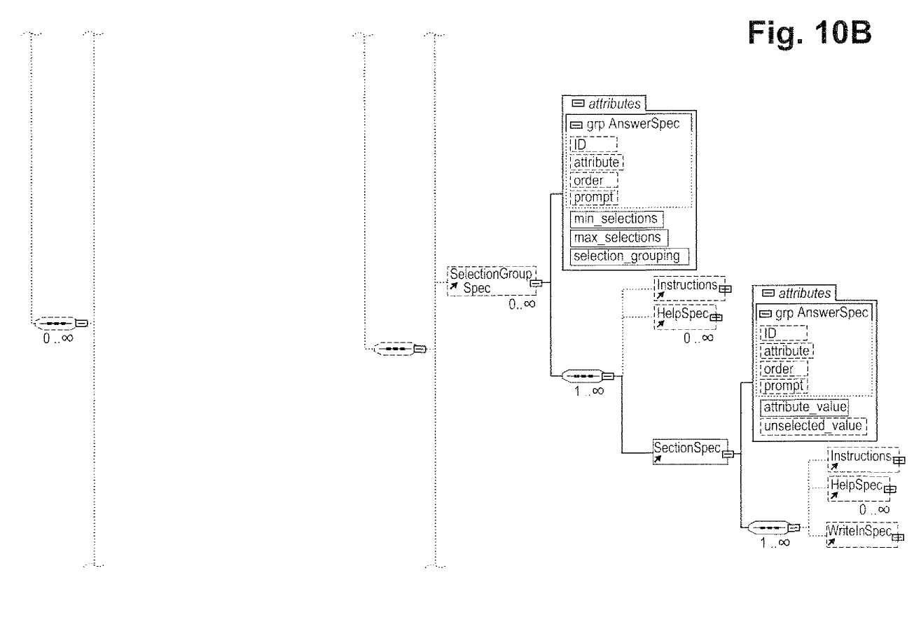

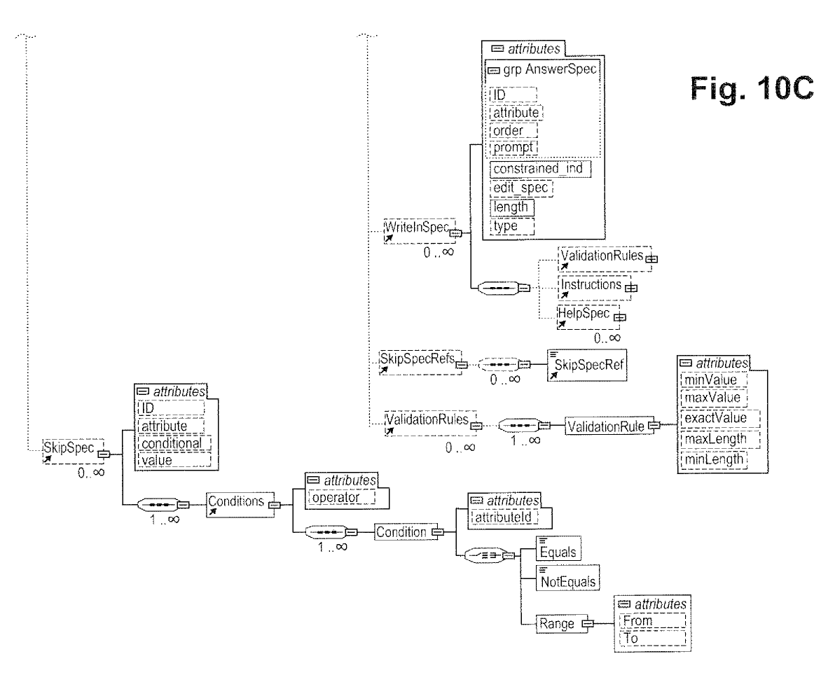

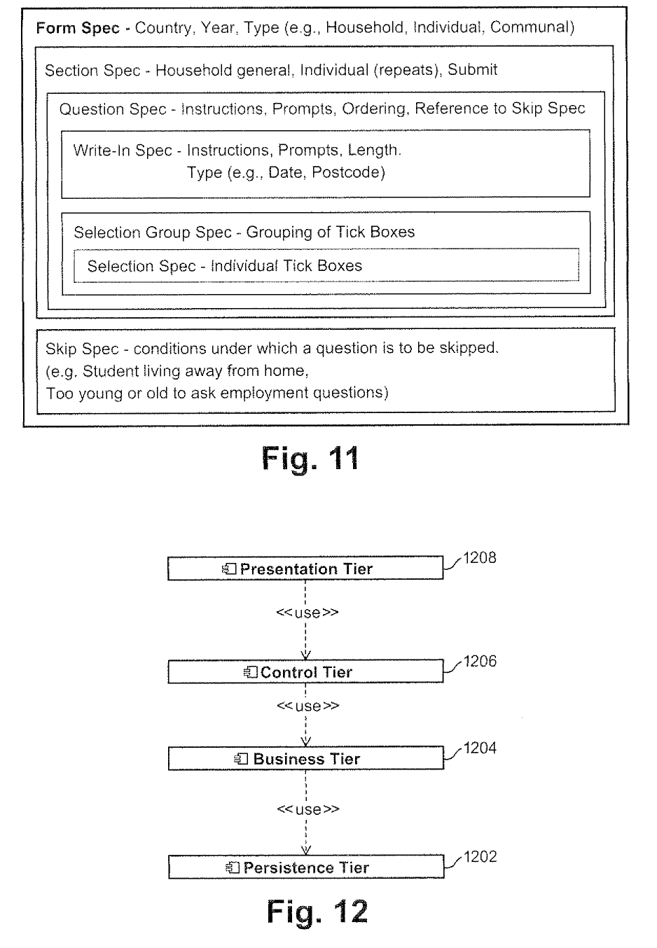

A description of example form schemas will now be made with reference to FIGS. 10A-C, which is an example XML schema definition in accordance with an example embodiment, and with reference to FIG. 11 which, compared to FIGS. 10A-C, is a more generalized form definition schema in accordance with an example embodiment.

5.4.2.1 Example Prompts and Instructions

An HTML form may be generated from an XML instance of the schema shown in FIGS. 10A-C, for example. The use of plain text for text elements in the form instance may be reduced to facilitate the switching of language on the fly. Accordingly, prompts, titles, and instructions values may be designed to be pointers to a language resource bundle. For example, in order to display a prompt on the form, the prompt element may be made to contain the key for the resource bundle:

```
<SectionSpec ID=“SEC_REP_1” order=“1”
  title=“SECTION_SEC_REP_1_TITLE” seq_number=“1”
  linkAnswerId=“user[ ]”>
    <QuestionSpec ID=“Q1” Optional_ind=“false”
      new_page_ind=“true” prompt=“QUESTION_Q1_PROMPT”
      repeatable=“true” seq_number=“1”>
      <WriteInSpec attribute=“age[ ]” ID=“W1” order=“1”
        constrained_ind=“true” prompt=“WRITEIN_W1_PROMPT”
        length=“50” edit spec=“” />
      </QuestionSpec>
```

As will be appreciated from the above, the title attribute on the SectionSpec element, and the prompt attribute of the QuestionSpec and the WriteInSpec elements are merely pointers to the resource bundle.

The resource bundle, in turn, may have the following entries:

| | |
|---|---|
| SECTION_SEC_REP_1_TITLE | = Person Details |
| for %%pname[ ]%% | |
| QUESTION_Q1_PROMPT | = Age |
| WRITEIN_W1_PROMPT | = Enter your age |

The form renderer will read the pointer from the form definition and then grab the actual text from the resource bundle to be displayed on the HTML form.

5.4.2.2 Example Substitution of Text With Previous Answers

Creating a resource bundle may provide the option to substitute parts of the text with previous answers that the user has inputted. For instance, when there is a repeated section, e.g., a section for each person in the roster, and when it desirable to display the actual person's name, the attribute name used to capture the person's name may be used as part of the text. This may be done by enclosing the text within an identifier (e.g., %%). In the resource bundle example above, it is noted that the SECTION SEC_REP_1_TITLE—Person Details for %% pname[ ]%% shows the attribute %% pname[ ]%% as a part of the text. At runtime, tire forms engine may replace the %% pname[ ]%% pointer with the appropriate person name from the rosier.

The substitution rules for repeated elements may be implemented as follows. If the user or respondent is in a repeated section, then the forms engine will try to replace an attribute name with the same sequence number as the repeated section sequence. For instance, if the user or respondent is in the second sequence of the repeated section and the forms engine wanls to display pname[ ] (e.g., according to tire design of the form), the forms engine may try to find the value of pname2. This may work by substituting text based on the value of the question that is used to determine how marry times to repeat the section. In the roster case, for example, the forms engine may repeat the person section a number of times corresponding to the user's or respondent's answer to the question of how may people there are in the household. Hence, the second sequence of the section will try to substitute the pname[ ] attribute with the previously user or respondent entered name of the second person.

If the user or respondent is attempting to use an answer that is not repeated or does not have at least as many answers as the number of the sequence iteration, then the forms engine may replace the attribute with the first sequence of the question, be it repeated or not.

A user or respondent also may substitute text from the current section, as well as from previous sections. In this case the substituted text may be the first sequence of the question in the current section. Accordingly, it may be advantageous to use questions that are not repeated rather than trying to substitute text from a repeated question inside the current section.

5.4.2.3 Example SkipSpec Logic

The following provides one example of how SkipSpecs may work with the forms engine of certain example embodiments. The following is a Simple SkipSpec, which is based on the AnswerSpec (which may be used in connection with a WriteInSpec or a SelectionSpec). In this example, the SkipLogic will be applicable if the user or respondent provides an answer for this AnswerSpec (zipCode in this ease) with the Value 22222.

```
<SkipSpec ID=“100” attribute=“” value=“”>
    <Conditions  operator=“AND”>
      <Condition attributeId=“zipCode”>
        <Equals>22222</Equals>
      </Condition>
    </Conditions>
</SkipSpec>
```

Any Question may use this SkipSpec using the syntax listed below. For example, to skip the following question based on the above SkipLogic, the question may refer to the above SkipSpec in the following manner:

```
<QuestionSpec optional_ind=“false” new_page_ind=“true”
  prompt=“QUESTION_1249011511962_PROMPT”
  repeatable=“true” >
    <SelectionGroupSpec
      . . .
    </SelectionGroupSpec>
    <SkipSpecRefs>
      <SkipSpecRef>100</SkipSpecRef>
    </SkipSpecRefs>
</QuestionSpec>
```

5.4.2.3 Example Repetitive Section/Questions

5.4.2.3.1 Example Questions

A Question may be repeated by specifying the repeatable attribute to true in the question element in the XML document as shown below. The default value is false.

```
<QuestionSpec optional_ind=“false” new_page_ind=“false”
  prompt=“QUESTION_1249011511963_PROMPT” repeatable=“true”>
    <WriteInSpec attribute=“user[ ]”  order=“1”
      constrained_ind=“true”
      prompt=“WRITEIN_1349011511964_PROMPT” length=“50”
      edit_spec=“”/>
</QuestionSpec>
```

Thus, in certain example embodiments, when this question is rendered, an add button may be shown (e.g., below the question) if the above flag is set to true.

5.4.2.3.2 Example Sections

A Section may be repeated based on the answers provided for a previous question that the user or respondent has answered. This may be achieved using the linkAnswerId attribute.

The following example shows how a section may be repeated. In this example, a person section is repeated for each household member that the user or respondent is going to enter. First, the following question may be used to gather the household information:

```
<QuestionSpec optional_ind=“false” new_page_ind=“false”
  prompt=“QUESTION_1249011511963_PROMPT” repeatable=“true”>
    <WriteInSpec attribute=“user[ ]”  order=“1”
      constrained_ind=“true”
      prompt=“WRITEIN_1349011511964_PROMPT” length=“50”
      edit_spec=“”/>
<QuestionSpec>
```

Then, the below Section may be repeated for each member in the household. The Section is based on the above question using the linkAnswerId attribute.

```
<SectionSpec ID=“SEC_REP_1” order=“1”
  title=“SECTION_SEC_REP_1_TITLE” seq_number=“1”
  linkAnswerId=“user[ ]”>
    <QuestionSpec ID=“Q1” optional_ind=“false”
      new_page_ind=“true” prompt=“QUESTION_Q1_PROMPT”
      repeatable=“true” seq_number=“1”>
      <WriteInSpec attribute=“age[ ]” ID=“W1” order=“1”
        constrained_ind=“true” prompt=“WRITEIN_W1_PROMPT”
        length=“50” edit_spec=“”/>
    </QuestionSpec>
    <QuestionSpec ID=“Q2” optional_ind=“false”
      new_page_ind=“false” prompt=“QUESTION_Q2_PROMPT”
      repeatable=“true” seq_number=“1”>
      <WriteInSpec ID=“W2” attribute=“car[ ]” order=“1”
        constrained_ind=“true” prompt=“WRITEIN_W2_PROMPT”
        length=“50” edit_spec=“”/>
    </QuestionSpec>
</SectionSpec>
```

The forms engine will handle the seq_number. For example, when the sections are dynamically created for each user or respondent, the forms engine may assign the next sequence number for the cloned/copied section. This sequence number may be used to facilitate storage of the information in the database.

5.4.2.4 Form Definition

As noted above, the questionnaire form may be defined as an XML document that conforms to an XML schema definition (described in greater detail below). The form definition may define the structure of the form including, for example, sections, questions, answers, help, skip logic, and/or the like.

Also as noted above, the application may be reused so as to enable display of the form definition in multiple languages and so as to be able to change languages on the fly. To support multiple languages, amount of text that needs to be displayed on the screen contained in the form definition, with the form definition instead including pointers to a resource bundle that contains the text in different languages.

One or more tools may be provided at design time. Such tools may include XML editing tools, XML validation tools (e.g., to catch malformed form definitions upstream of the application), errors of intent (e.g., a skip to a non-existent spec, min>max condition, etc.), and/or the like.

5.4.3 Design Overview

FIG. 12 shows example system tiers in accordance with an example embodiment. More particularly, as shown in FIG. 12, the system may be built in four layers. A data layer or persistence tier 1202, may comprise entity beans that represent tables and a DataAccessBeam which is a utility class configured to handle database operations. The data layer or persistence tier 1202 may be built on top of Hibernate so as to provide easy access to the database. The business tier 1204 may include business logic broken down into two components. A QuestionManager may load the appropriate form and display the appropriate questions on the current page, and an AnswerProcessor may validate and persist the answer. A control tier 1206 may be a simple HTTP servlet that forwards the request to the appropriate class for processing (e.g., to the QuestionManager, AnswerProcessor, etc.). Finally, the presentation tier 1208 may include a set of JSP pages that process the data sent by the QuestionManager and also may render the HTML page from the XML form definition, the resource bundle, and the CSS and images. Each of these layers will be described in greater detail in the following sections.

5.4.3.1 Example Data Layer or Persistence Tier

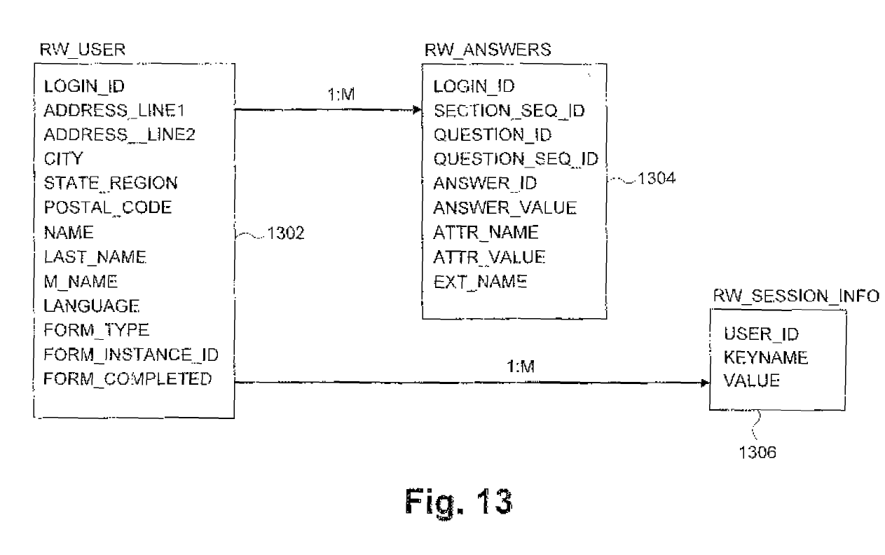

The data from the online forms is captured every time the user is navigates to the next or previous page. The database may comprise the tables shown in FIG. 13 and described below, for example. Thus, FIG. 13 is an example database usable in a data layer or persistence tier in an illustrative system in accordance with an example embodiment.

RW_USER table 1302 authenticates the user and load the appropriate form. It may include the following fields:

| Column | Type | Size | Usage |
|---|---|---|---|
| LOGIN_ID | Varchar2 | 200 | The unique login number that identifies the |
| | | | user or respondent |
| ADDRESS_LINE_1 | Varchar2 | 200 | Address Line 1 |
| ADDRESS_LINE_2 | Varchar2 | 200 | Address Line 2 |
| CITY | Varchar2 | 200 | City |
| STATE_REGION | Varchar2 | 200 | State or region |
| POSTAL_CODE | Varchar2 | 20 | Postal Code |
| NAME | Varchar2 | 50 | First name |
| LAST_NAME | Varchar2 | 50 | Last name |
| M_NAME | Varchar2 | 50 | Middle name |
| LANGUAGE | Varchar2 | 20 | Default language |
| FORM_TYPE | Varchar2 | 20 | The form type that the user needs to fill in |
| FORM_INSTANCE_ID | Varchar2 | 256 | The form's HASH code. The code is saved |
| | | | once the user started to fill in the form. It |
| | | | may be used to determine if the form has |
| | | | changed sine the last time the user has |
| | | | logged in |
| FORM_COMPLETED | Number | | If this value equals 1, then the user has |
| | | | submitted the from and cannot log in again |

RW_ANSWERS table 1304 may store the user's or respondent's answers to the questions. It may include the following fields:

| Column | Type | Size | Usage |
|---|---|---|---|
| LOGIN_ID | Varchar2 | 200 | User's login ID |
| SECTION_SEQ_ID | Varchar2 | 10 | The section's sequence number |
| QUESTION_ID | Varchar2 | 10 | The question's ID |
| QUESTION_SEQ_ID | Varchar2 | 10 | The question's sequence number |
| ANSWER_ID | Varchar2 | 50 | The answer (WriteInSpce or SelectionSpce) |
| | | | ID |
| ANSWER_VALUE | Varchar2 | 4000 | The actual answer the user entered for the |
| | | | question |
| ATTR_NAME | Varchar2 | 50 | The attribute name from the form's XML |
| | | | instance |
| ATTR_VALUE | Varchar2 | 4000 | The value for the attribute. This value is |
| | | | calculated with the concatenation rules, |
| EXT_NAME | Varchar2 | 50 | The external system attribute name. This is |
| | | | the same as the ATTR_NAME. but it may |
| | | | be parsed and the [ ] replaced with the actual |
| | | | sequence number |

RW_SESSION INFO table 1306 may save session information that persists across sessions. It may include the following fields:

| Column | Type | Size | Usage |
|---|---|---|---|
| USERID | Varchar2 | 255 | The user ID |
| KEYNAME | Varchar2 | 255 | The key |
| VALUE | Varchar2 | 255 | The value |

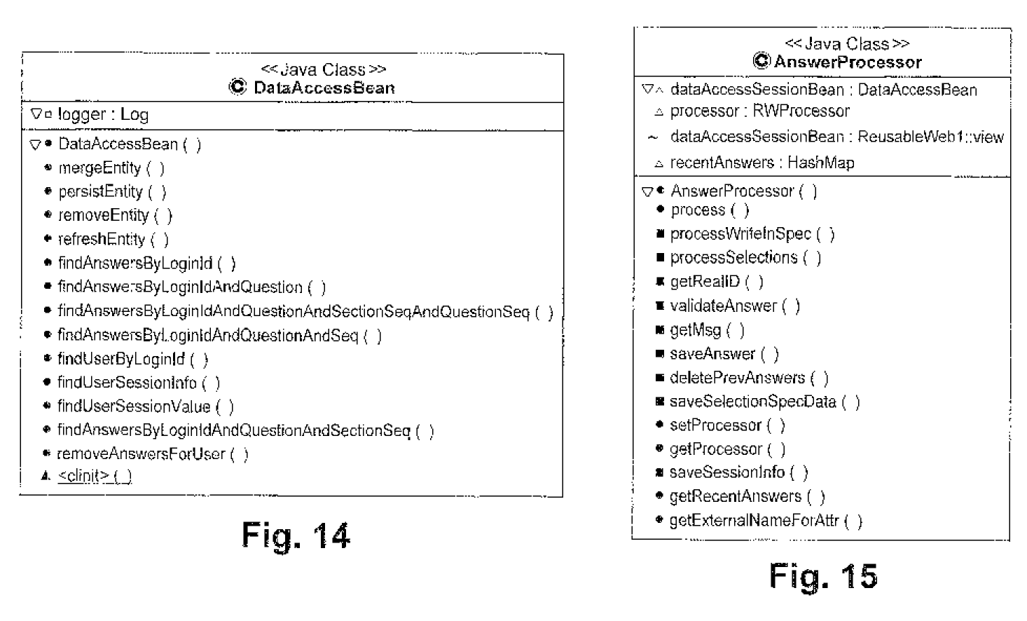

As noted above, the Hibernate frame work may be used for database access. The data access may comprise two components. The first component is a data access class (e.g., entity beans). These classes map the database schema to Java objects. These classes may include, for example, Answers, SessionInfo, and User. The second component is a data access bean that performs the database operations (e.g., queries and updates) using the entity beans. The DataAccessBean is a central place where all database communication is handled. FIG. 14 is an illustrative DataAccessBean in accordance with an example embodiment.

Hibernate may use mapping information to generate the queries and the JDBC code to use those queries at runtime. Example mapping information for the answers table is provided below:

```
<hibernate-mapping schema=”iraduser” package=”view”>
    <class name=”Answers” table=”RW_ANSWERS” optimistic-
      lock=”none”>
      <composite-id class=”AnswersPK” mapped=”true”>
        <key-property name=”loginId” column=”LOGIN_ID”/>
        <key-property name=”sectionSeqId”
          column=”SECTION_SEQ_ID”/>
        <key-property name=”questionSeqId”
          column=”QUESTION_SEQ_ID”/>
        <key-property name=”questionId”
          column=”QUESTION_ID”/>
        <key-property name=”answerId” column=”ANSWER_ID”/>
      </composite-id>
    <property name=”answerValue” type=”string”
      column=”ANSWER_VALUE” length=”4000” not-null=”true”/>
    <property name=”attrValue” type=”string”
      column=”ATTR_VALUE” length=”1000” />
    <property name=”attrName” type=”string”
      column=”ATTR_NAME” length=”50” />
    <property name=”extName” type=”string” column=”EXT_NAME”
      length=”50” />
    </class>
</hibernate-mapping>
```

5.4.3.2 Example Business Tier

5.4.3.2.1 Example AnswerProcessor

The answer processor is responsible for processing the user's answers, checking for constraints, and saving the answers to the database. Every button click causes an implicit “submit” to the server. The request then is forwarded to the answer processor to process the user's answer.

The answer processor first checks to see whether the answers are changes from the previous submitted answers, or if they are new answers to questions that have never been answered. If an answer to a question has been changed, the answer processor deletes all previous answers for that question (although a question may have multiple answer fields). The answer processor then validates the answer and if it is a valid answer (e.g., passed constraint requirements), then the answer will be saved. If a validation error is detected, a message may be added in the error message map.

After all the answers for tire submitted page have been processed, the answer processor may check to see if there are some unanswered questions (e.g., questions with a required flag). If there are still unanswered questions, the answer processor may insert an error message to the error message map.

FIG. 15 is an example AnswerProcessor JAVA class in accordance with an example embodiment.

5.4.3.2.1.1 Saving Answers

Saving the answers may involve creating an answer object and calling a DataAccessBean to persist. After the database is updated, the answer processor also may put the answer value in an internal hash map for future reference and fast data retrieval. In addition, the AnswerProcessor also may save some session information such as, for example, the last question submitted, the current sequence numbers, the current section, etc. This information may be used later for the left navigation, e.g., to link the sections until the last section is submitted. The last question may be used to position the user or respondent on that page if the session is resumed at a later time.

5.4.3.2.1.2 Example HashMaps

Several HashMaps may be managed in memory. The hash maps may be used during the user's or respondent's session for fast data retrieval and to reduce the load on the database. These HashMaps may include, for example:
AnswersMap: Maps the users or respondent's answers. The key field is AnswerID, which is generated in runtime for each WriteInSpec and SelectionSpec, and the value is the HTML value. This man may be used to re-display the answers on an HTML page as after a user has entered them and navigated backwards.
recent Answers: Holds only the answer or answers that was or were submitted in the last page.
Attribute Answer Map: Maps the external attribute name with the users answer. This map may be used to evaluate the answers in the skip spec and to do text substitution for the prompts, instructions, etc.
UserProp: Stores the user's or respondent's session information such as, for example, the last section the user or respondent is in, the last question submitted, current language, etc.

5.4.3.2.2 Example QuestionManager

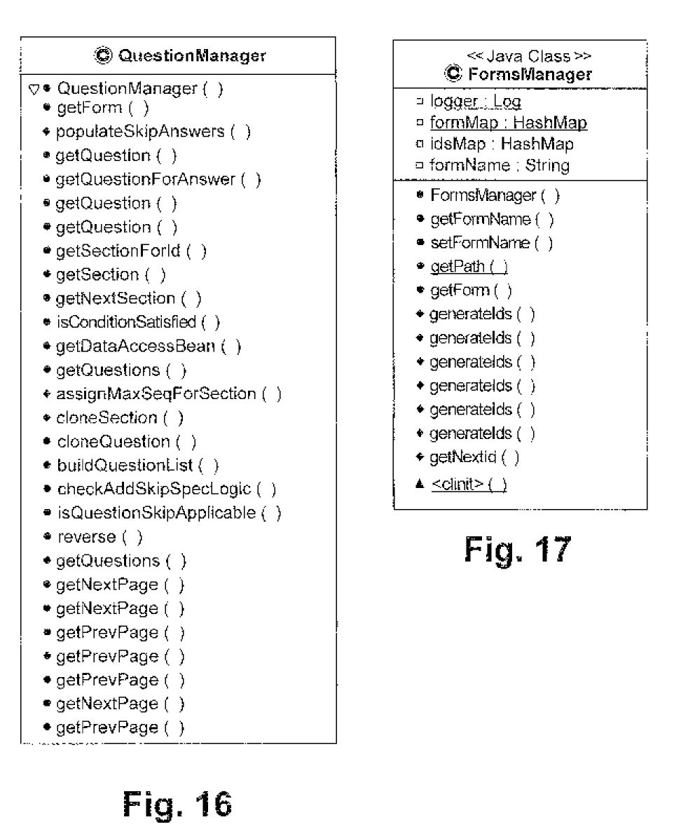

The QuestionManager is a class that is responsible for generating the questions that need to be displayed in a page. This class may take care of splitting sections across multiple pages, e.g., using the new page ind flags specified in the XML files, and also the repeating sections based on the answers supplied for a previous question on which the section depends. FIG. 16 is an example QuestionManager JAVA class in accordance with an example embodiment.

5.4.3.2.3 Example FormsManager

The FormsManagcr is a class that is responsible for loading the questions into the Application from the XML instances supplied. This class may generate the IDs for the elements, except for those that already have a value for the ID attribute. This class may cache the form instances so that they will be loaded only once during the application startup. FIG. 17 is an example FormsManager JAVA class in accordance with an example embodiment.

5.4.3.2.4 Example RWProcessor

The RWProcessor is a business layer class that may implement most of the system's functionality with the help of other helper classes, including the QuestionManager, FormsManager, and AnswerProcessor. Using this application, a user or respondent may perform a number of operations including, for example, login, goToNextPage, GoToPrevPage, addQuestion, etc. Each of these operations are described in greater detail below.
Login: When a user or respondent enters an Internet Code, the user or respondent is authenticated and the forms that are assigned to the authenticated user or respondent are loaded into the system and are presented.
goToNextPage: Once is user or respondent is logged in successfully, the form that needs to be filled in will be displayed, and the user or respondent can navigate to the next page using a button. This functionality is achieved using this action. Additionally, this action may process the data the user or respondent has submitted in the current form, build the next page, and display the questions to the user or respondent. It may also fetch the answers the user or respondent might have filled in during the previous visit if applicable.
goToPrevPage: This action functions similar to the goToNextPage action.
addQuestion: Some of the questions displayed as part of the form can be repetitive, and the user or respondent can add and answer such questions any number of lines using this Action. When a user or respondent tries to add a question, the data entered thus far may be processed and saved in the database.

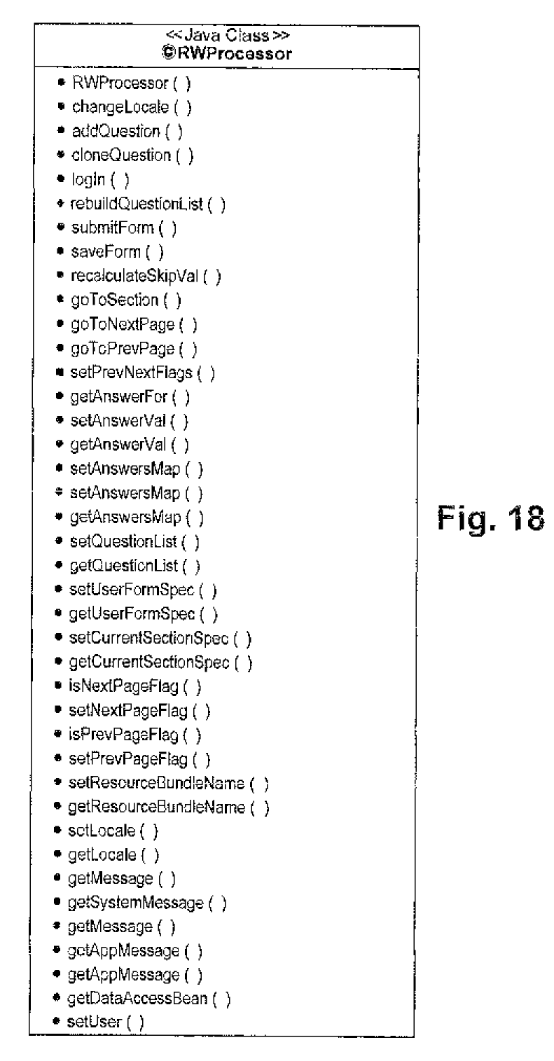

FIG. 18 is an example RWProcessor JAVA class in accordance with an example embodiment.

5.4.3.3 Example Control Tier

The ActionServlet class may serve as the application controller. It may help process the HTTP request and initiate the appropriate actions. After processing has completed, the ActionServlet may forward the request back to the JSP that renders the HTML form. In this regard, the ActionServlet class may include functions such for getting, posting, transferring message, etc.

5.4.3.4 Example Presentation Tier

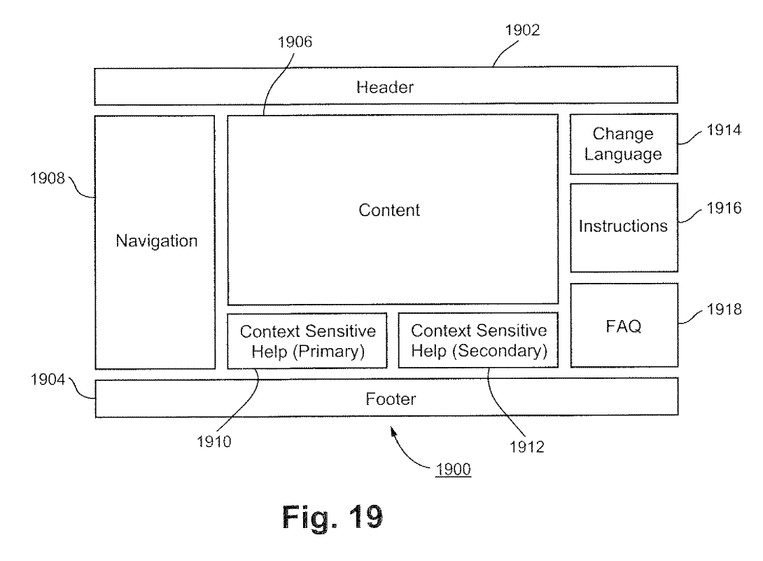

FIG. 19 is an example page layout showing example page elements in accordance with an example embodiment. As shown in FIG. 19, the page 1900 includes a header 1902 and a foot 1904. Main content 1906 is provided in the center of the page 1900. The generation of this content 1906 is described below. Navigation 1908 is provided via an area to the left of the screen. Primary and secondary context sensitive help 1910 and 1912 may be provided below the content 1906 but above the footer 2204. The primary and secondary context sensitive help 1910 and 1912 may display help screens for the user or respondent in dependence on the content 1906. A user or respondent may change language on the fly using a change language feature 1914 (e.g., by selecting from a drop-down list, choosing from a menu, clicking a radio button, etc.). Instructions may be accessible by instructions feature 1916. A list of frequently asked questions also may be displayed by clicking FAQ feature 1918. It will be appreciated that the above description and the layout shown in FIG. 19 is provided by way of example. Other layouts with the same and/or other elements also may be provided in other example embodiments.

The page may be rendered by JSP templates in certain example embodiments. The actual form for the main content may be rendered by the form formBody.jsp page. The formBody JSP template may retrieve the list of questions from the session, which may be pre-prepared and put into the session by the RWProcessor. It may loops through the list and, for each WriteInSpec, SelectionGroup, and SelectionSpec, it may generate the appropriate HTML elements. The formBody JSP template also may make calls to retrieve the actual text from the resource bundle.

For radio buttons and check boxes, a page may be rendered with the value at tribute as the ID of the SelectionSpec item; and the name attribute as the ID of the SelectionGroup. When the answer is being processed, the AnswerProcessor may then read the actual valise of the SelectionSpec from the form definition. This approach may help identify the actual selected items so that the composite value may be calculated as a concatenation or addition of all the selection items.

The left navigation may show the user or respondent the sections of the form and indicates the progress the user or respondent is making. It may read the current section information (which may be stored in the session), and retrieve the list of sections from the form definition. They may then be displayed in the left navigation box. For each section the user has filled in, the leftNavigation may create a link that enables the user to go back to the first question of that section. For repeating sections, the link may take a user or respondent to the first iteration of the section, and thus the first sequence of that repeating section.

5.5 Example XML Schema Design

5.5.1 Introduction to Example Schema Structure

This section provides information on an example schema itself and discusses the illustrative design as well as some of the rationale behind the schema itself including, for example, further details as to how the schema may relate to the form engine of certain example embodiments. The XML schema design (XSD) of certain example embodiments helps to improve the creation, maintenance, and operation of a system to conduct Internet-based questionnaires and surveys such as, for example, those used to conduct a census. The schema allows users to specify the structure and navigation logic of the questionnaire, substantially independent of a generalized engine that interprets a questionnaire specification and engages a user in an interactive session to capture the user's responses. In this regard, this section describes elements of the schema and identifies the features and rationale for its existence, constituent elements, and attributes.

The schema may be organized as a hierarchy. Within the hierarchy, at each level, attributes and/or sub-elements may be provided. The hierarchy of an XSD in accordance with an example embodiment is described below in connection with the following notation:
Element—A hierarchical node comprising one or more attributes and Elements
Element [symbol] Element—A hierarchical node comprising one or more attributes and Elements
Element [symbol] Element [symbol] Element—etc.
attribute—a bit of descriptive information associated with the Element listed immediately above it.

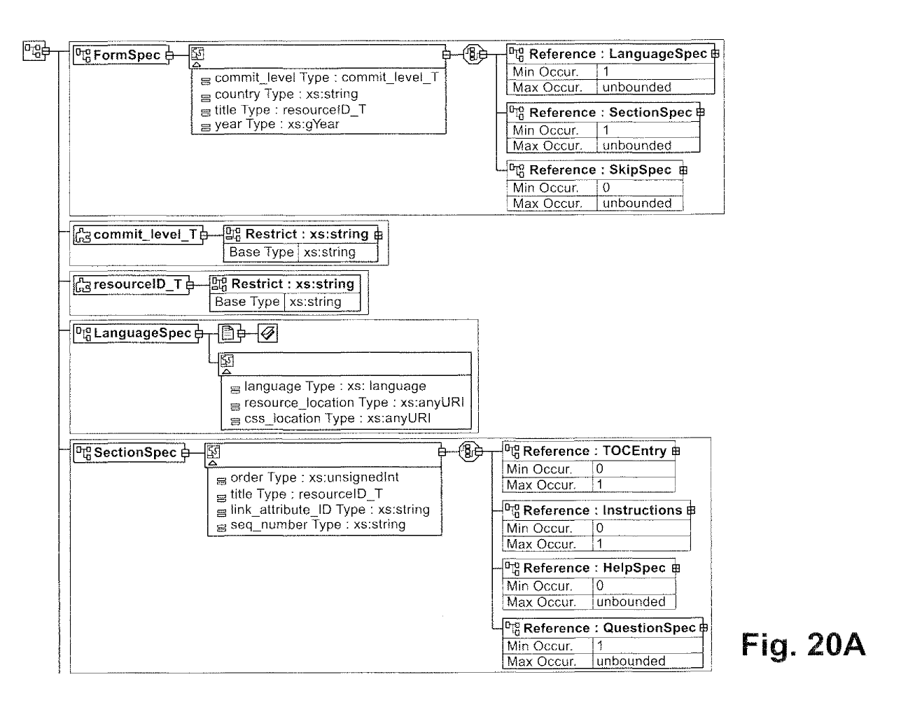

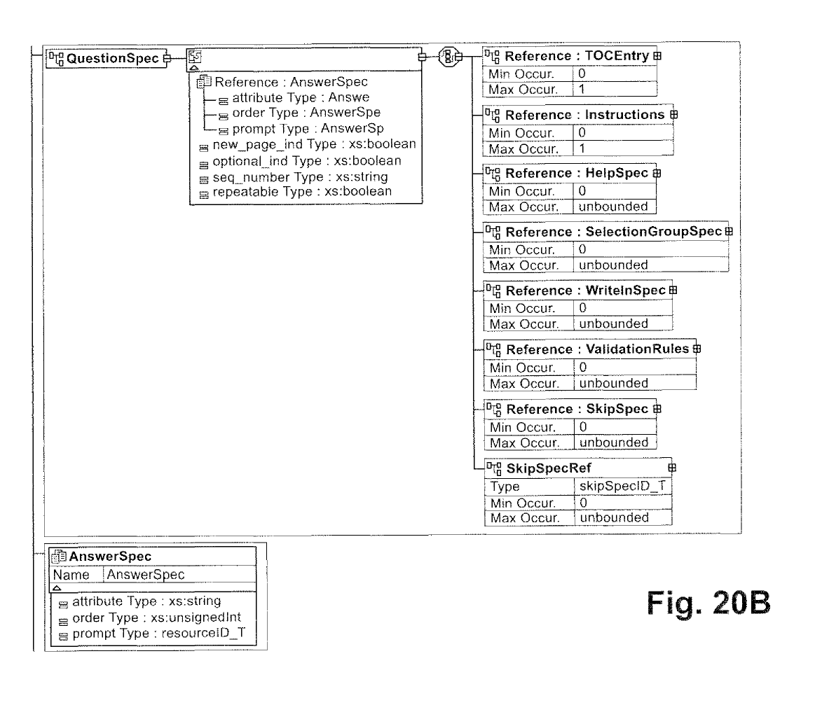

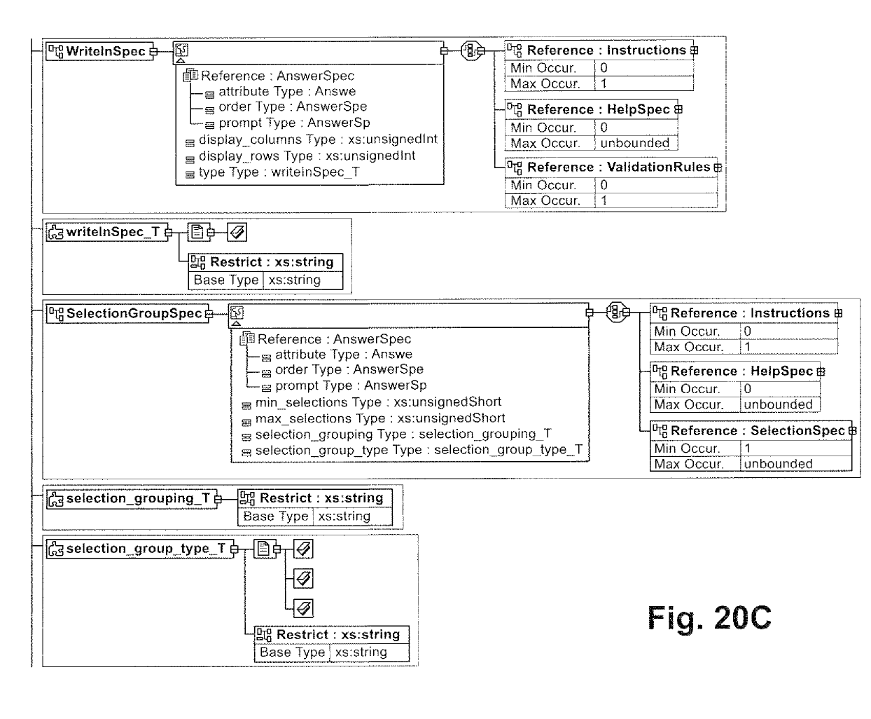

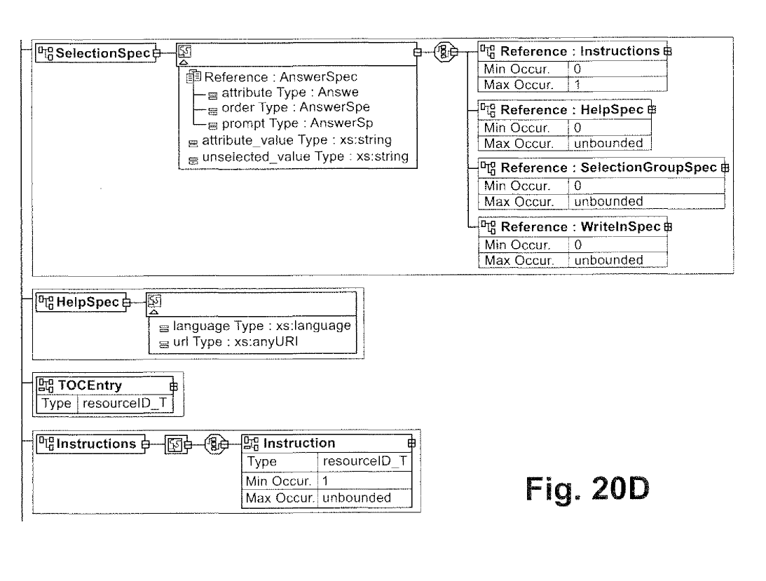

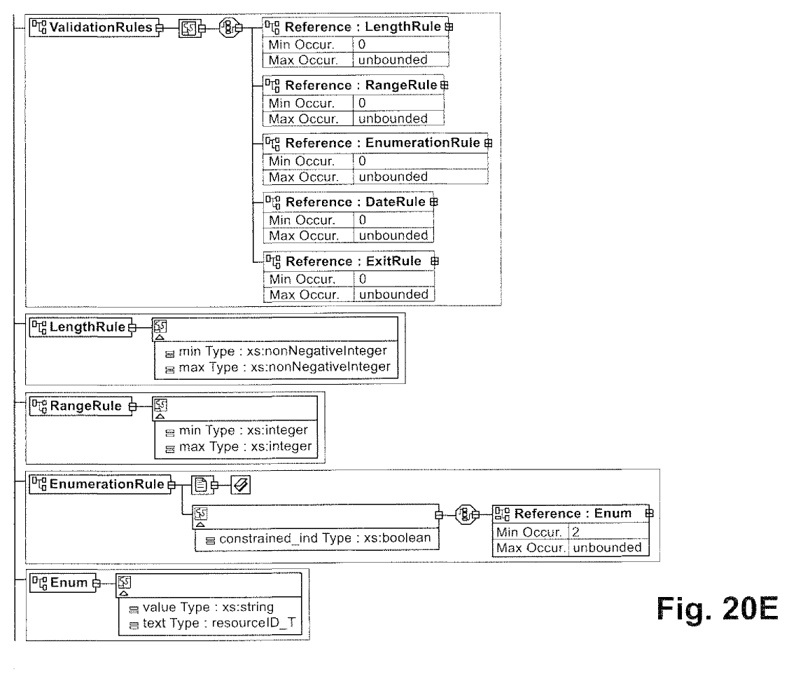

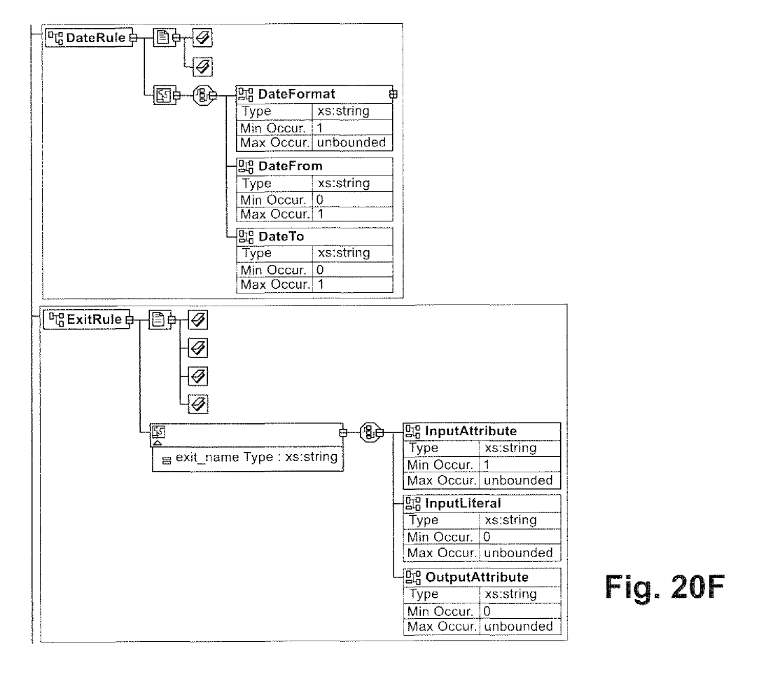

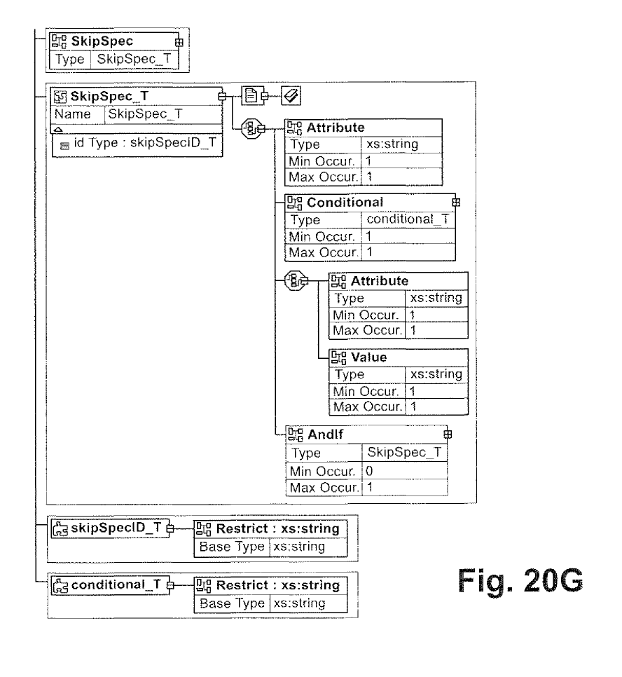

The example schema structure described below is shown visually, for example, in FIGS. 20A-G,

5.5.1 Example Schema Document Properties

A target namespace may be specified for example schema documents. The global element and a attribute declarations (e.g., as described below) may belong to the schema's target namespace. By default, local element declarations belong to the schema's target namespace, although local attribute declarations have no default namespace.

A number of namespaces may be declared, for example, by using prefixes with corresponding namespaces, in certain example embodiments, the following prefixes and namespaces may be mapped, thereby importing the standards, features, and functionality of the same:

| Prefix | Namespace |
|---|---|
| Default namespace | http:///www.census-provider.com |
| xml | http://www.w3.org/XML/1998/namespace |
| xs | http://www.w3.org/2001/XMLSchema |

Of course, it will be appreciated that other namespaces may be used in connection with these and/or other prefixes.

By way of example and without limitation, the schema component representation for schema document properties may be as follows:

```
xs:schema elementFormDefault=“qualified”
    targetNamespace=“http://www.census-provider.com”>
      ...
</xs:schema>
```

5.5.2 Example Global Declarations in Example XSD

The FormSpec element is the highest level organizational structure for the form specification. It defines globally applicable information. Its attributes include:
country
year
commit_level—indicates whether to persist answers to questions as the user enters them or only when an entire section is complete. This allows for system optimization and reduces the potential for data loss, and/or for optimization for use with a minimal hardware configuration. To persist each screen's answers as they are received, certain example embodiments may support a much higher transaction rate against the database with correspondingly higher server and disk I/O resources. For some customers, this is preferable, as it makes for a much more satisfying experience for users whose Internet connections may not be very stable.
title—indirectly defined (similar to other textual content) through reference to a resource file that contains key/value pairs including the reference id and the actual text displayed to the user. By separating out the actual text, it is possible to respond to changes in content without modifying and having to re-test the structural definition. This also allows for the use of a common structural definition to support multiple languages such as English, Welsh, French, Spanish, etc., as the customer may require.

In certain example embodiments, the XML Instance Representation of a FormSpec element may be as follows:

```
<FormSpec
  commit_level=“commit_level_T [0..1]”
  country=“xs:string [0..1]”
  title=“resourceID_T [0..1]”
  year=“xs:gYear [0..1]”>
      <LanguageSpec> ... </LanguageSpec> [1..*]
      <SectionSpec> ... </SectionSpec> [1..*]
      <SkipSpec> ... </SkipSpec> [0..*]
</FormSpec>
```

In certain example embodiments, the Schema Component Representation of a FormSpec element may be as follows:

```
<xs:element name=“FormSpec”>
    <xs:complexType>
      <xs:sequence minOccurs=“1” maxOccurs=“1”>
        <xs:element ref=“LanguageSpec” minOccurs=“1”
          maxOccurs=“unbounded”/>
        <xs:element ref=“SectionSpec” minOccurs=“1”
          maxOccurs=“unbounded”/>
        <xs:element ref=“SkipSpec” minOccurs=“0”
          maxOccurs=“unbounded”/>
      </xs:sequence>
      <xs:attribute name=“commit_level”
        type=“commit_level_T” use=“optional”/>
      <xs:attribute name=“country” type=“xs:string”
        use=“optional”/>
      <xs:attribute name=“title” type=“resourceID_T”
        use=“optional”/>
      <xs:attribute name=“year” type=“xs:gYear”
        use=“optional”/>
    </xs:complexType>
</xs:element>
```

The FormSpec [symbol] LangageSpec element identifies the languages supported, as well as the corresponding resource files and cascading style sheet (CSS) files that the engine will use to substitute text and to send to the browser to format the page. The languages supported for each form specification may be defined by writing multiple instances of LanguageSpec so that the engine may swap between supported languages dynamically as requested by the user. Its attributes include:
language—specifies a language supported for this form.
resource_location points to the resource file that specifies the resource IDs and corresponding text for such things as titles, instructions, and prompts.
css_location—points to the CSS file that the engine is to use to instruct the user's browser how to format the screen.

In certain example embodiments, the XML Instance Representation of a LanguageSpec element may be as follows:

```
<LanguageSpec
  language=“xs:language [1]”
  resource_location=“xs:anyURI [0..1]”
  css_location=“xs:anyURI [0..1]”/>
```

In certain example embodiments, the Schema Component Representation of a Language Spec element may be as follows:

```
<xs:element name=“LanguageSpec”>
    <xs:complexType>
      <xs:attribute name=“language” type=“xs:language”
        use=“required”/>
      <xs:attribute name=“resource_location”
        type=“xs:anyURI” use=“optional”/>
      <xs:attribute name=“css_location” type=“xs:anyURI”
        use=“optional”/>
    </xs:complexType>
</xs:element>
```

The FormSpec [symbol] SectionSpec element marks any major subdivisions of the form. Examples are general household information, person specific information, and ready-to-submit sections. Its attributes include:
title—See FormSpec [symbol] title
order—refers to the order in which the engine is to process and/or display the section, relative to any other sections
link_attribute_ID—points to an attribute name that allows the engine to repeat this section for each answer received for a prior repeating question (e.g., the value associated with FormSpec [symbol] SectionSpec [symbol] QuestionSpec [symbol] attribute—the variable name like firstName [ ]). An example usage would be a general household information section containing a question that asks the user to enter a variable length roster for the household. The person-specific information section may be defined to be repeating based on the number of persons entered into the roster. This ability to dynamically expand the questionnaire in response to previous entries is a feature of the schema and form engine. This avoids having to have continuation forms as is the case with paper which, by its very nature, is limited in the number of pages printed. In other words, the form expands and contracts dynamically as the user adds people to or removes them from the roster.

In certain example embodiments, the XML Instance Representation of a FormSpec [symbol] SectionSpec element may be as follows:

```
<SectionSpec
  order=“xs:unsignedInt [1]”
  title=“resourceID_T [0..1]”
  link_attribute_ID=“xs:string [0..1]”
  seq_number=“xs:string [0..1]”>
      <TOCEntry> ... </TOCEntry> [0..1]
      <Instructions> ... </Instructions> [0..1]
      <HelpSpec> ... </HelpSpec> [0..*]
      <QuestionSpec> ... </QuestionSpec> [1..*]
</SectionSpec>
```

In certain example embodiments, the Schema Component Representation of a FormSpec [symbol] SectionSpec element may be as follows:

```
<xs:element name=“SectionSpec”>
    <xs:complexType>
      <xs:sequence minOccurs=“1” maxOccurs=“1”>
        <xs:element ref=“TOCEntry” minOccurs=“0”
          maxOccurs=“1”/>
        <xs:element ref=“Instructions” minOccurs=“0”
          maxOccurs=“1”/>
        <xs:element ref=“HelpSpec” minOccurs=“0”
          maxOcuurs=“unbounded”/>
        <xs:element ref=“QuestionSpec” minOccurs=“1”
          maxOccurs=“unbounded”/>
      </xs:sequence>
      <xs:attribute name=“order” type=“xs:unsingnedInt”
        use=“required”/>
      <xs:attribute name=“title” type=“resourceID_T”
        use=“optional”/>
      <xs:attribute name=“link_attribute_ID”
        type=“xs:string” use=“optional”/>
      <xs:attribute name=“seq_number” type=“xs:string”
        use=“optional”/>
    </xs:complexType>
</xs:element>
```

The FormSpec [symbol] SectionSpec [symbol] TOCEntry element is an optional element that tells the engine to make a link available to the user that allows the user to quickly navigate to this section. A resource ID reference may be used to specify the text that the engine will use for the link.

In certain example embodiments, the XML Instance Representation of a FormSpec [symbol] SectionSpec [symbol] TOCEntry element may be as follows:
<TOCEntry> resourceID_T </TOCEntry>

In certain example embodiments, the Schema Component Representation of a FormSpec [symbol] SectionSpec [symbol] TOCEntry element may be as follows:
<xs: element name“TOCEntry” type=“resourceID_T”/>

The FormSpec [symbol] SectionSpec [symbol] Instructions element is an optional and/or repeating element that specifies text that the engine will output. Like all elements that produce text output, the Instructions element implies an associated CSS style that a browser will use to format the text in a particular way. For example, the form's style sheet may specify that a browser format multiple Instructions elements for a section as bulleted list.

In certain example embodiments, the XML Instance Representation of a FormSpec [symbol] SectionSpec [symbol] Instructions element may be as follows:

<Instructions>
<Instruction> resourceID_T </Instruction> [1..*]
</Instructions>

In certain example embodiments, the Schema Component Representation of a FormSpec [symbol] SectionSpec [symbol] Instructions element may be as follows:

```
<xs:element name=“Instructions”>
  <xs:complexType>
  <xs:sequence minOccurs=“1” maxOccurs=“1”>
    <xs:element name=“Instruction” type=“resourceID_T”
      minOccurs=“1” maxOccurs=“unbounded”/>
  </xs:sequence>
  </xs:complexType>
</xs:element>
```

The FormSpec [symbol] SectionSpec [symbol] HelpSpec element is an optional element that tells the engine that there is associated context sensitive help. Its attributes include:
language—if there are multiple FormSpec [symbol] LanguageSpecs for a form, then a HelpSpec may specify the language attribute so the engine will know the correct content to display based on the user's currently selected language.
url—specifies the location of the associated context sensitive help content.

In certain example embodiments, the XML Instance Representation of a FormSpec [symbol] SectionSpec [symbol] HelpSpec element may be as follows:

```
<HelpSpec
  language=“xs:language [0..1]”
  url=“xs:anyURI [1]”/>
```

In certain example embodiments, the Schema Component Representation of a FormSpec [symbol] SectionSpec [symbol] HelpSpec element may be as follows:

```
<xs:element name=“HelpSpec”>
  <xs:complexType>
    <xs:attribute name=“language” type=“xs:language”
      use=“optional”/>
    <xs:attribute name=“url” type=“xs:anyURI”
      use=“required”/>
  </xs:complexType>
</xs:element>
```

The FormSpec [symbol] SectionSpec [symbol] QuestionSpec element may be required. Its attributes include:
attribute—specifies a name (key) used to pair with an input value (or value previously entered and stored). Attribute can be specified at the FormSpec [symbol] SectionSpec [symbol] QuestionSpec level or at the level of some of its sub-elements, but only at one level for a given Question. For example, a simple question may specify the attribute name at the question level. A more complex question may involve assigning values to an attribute name at the FormSpec [symbol] SectionSpec [symbol] QuestionSpec [symbol] SelectionGroupSpec [symbol] SelectionSpec (e.g., tick box) level in which case the attribute name at the FormSpec [symbol] SectionSpec [symbol] QuestionSpec and FormSpec [symbol] SectionSpec [symbol] QuestionSpec [symbol] SelectionGroupSpec levels are null. As such, the schema defines this attribute to be optional at the FormSpec [symbol] SectionSpec [symbol] QuestionSpec and lower levels. Semantically, it may be specified at some level if an answer to the question is expected. It will be appreciated that not all questions will require answers as is the case if the questionnaire includes a question that is nothing more than instructions or information about what the user should expect to see or do next.
order—used the same way here as for FormSpec [symbol] SectionSpec [symbol] order, and defines the sequence in which the engine displays and/or processes questions within a section and may be a required attribute. By outputting the value of this attribute in the HTML/XHTML stream, the engine in conjunction with the CSS file may cause the browser to display the number in a particular format as may be the case if the customer desires to display the question number in a particular format.
prompt—similar to the FormSpec [symbol] SectionSpec [symbol] Instructions element. Where the Instructions element is normally expected to present narrative text to guide the user to answer a question or not or to answer it in a certain way, the prompt may be used to identify text that may be the body of the question itself such as, for example, “What is the sex for this person?” This attribute may be used again in sub-elements of FormSpec [symbol] SectionSpec [symbol] QuestionSpec. For example, to specify text that identifies options in a list that from which the user may select (e.g., “Male” and “Female,” alongside of a pair of radio buttons).
new_page_ind—indicates whether this question starts a new page (screen) and may be required. If set to “FALSE,” the engine outputs this question on the same screen as the previous question. This allows the form designer to specify, for example, that the user should see and answer short questions such as age and sex on the same screen.
optional_ind—tells the engine whether or not to require a response from the user before proceeding. The engine has a default resource ID from that it derives text to display using a default style if the user does not provide an answer to a required question.
repeatable—indicates that the engine must allow the user to answer the question multiple times as might be the case if collecting for example a list of names for a household roster. attribute should contain the “[ ]” string to indicate where index characters go in the resolved attribute name, (e.g., “surName [ ]”). Repeatable questions and the resulting ability to have repeatable sections are key features of the schema and form engine.

In certain example embodiments, the XML Instance Representation of a FormSpec [symbol] SectionSpec [symbol] QuestionSpec element may be as follows:

```
<QuestionSpec
  attribute=“xs:string [0..1]”
  order=“xs:unsignedInt [1]”
  prompt=“resourceID_T [0..1]”
  new_page_ind=“xs:boolean [1]”
  optional_ind=“xs:boolean [1]”
  seq_number=“xs:string [0..1]”
  repeatable=“xs:boolean [0..1]”>
    <TOCEntry> ... </TOCEntry> [0..1]
    <Instructions> ... </Instructions> [0..1]
    <HelpSpec> ... </HelpSpec> [0..*]
    <SelectionGroupSpec> ... </SelectionGroupSpec> [0..*]
    <WriteInSpec> ... </WriteInSpec> [0..*]
    <ValidationRules> ... </ValidationRules> [0..*]
    <SkipSpec> ... </SkipSpec> [0..*]
    <SkipSpecRef> skipSpecID_T </SkipSpecRef> [0..*]
</QuestionSpec>
```

In certain example embodiments, the Schema Component Representation of a FormSpec [symbol] SectionSpec [symbol] QuestionSpec element may be as follows:

```
<xs:element name=“QuestionSpec”>
  <xs:complexType>
    <xs:sequence minOccurs=“1” maxOccurs=“1”>
      <xs:element ref=“TOCEntry” minOccurs=“0”
        maxOccurs=“1”/>
      <xs:element ref=“Instructions” minOccurs=“0”
        maxOccurs=“1”/>
      <xs:element ref=“HelpSpec” minOccurs=“0”
        maxOccurs=“unbounded”/>
      <xs:element ref=“SelectionGroupSpec” minOccurs=“0”
        maxOccurs=“unbounded”/>
      <xs:element ref=“WriteInSpec” minOccurs=“0”
        maxOccurs=“unbounded”/>
      <xs:element ref=“ValidationRules” minOccurs=“0”
        maxOccurs=“unbounded”/>
      <xs:element ref=“SkipSpec” minOccurs=“0”
        maxOccurs=“unbounded”/>
      <xs:element name=“SkipSpecRef” type=“skipSpecID_T”
        minOccurs=“0” maxOccurs=“unbounded”/>
    </xs:sequence>
    <xs:attributeGroup ref=“AnswerSpec”/>
    <xs:attribute name=“new_page_ind” type=“xs:boolean”
      use=“required”/>
    <xs:attribute name=“optional_ind” type=“xs:boolean”
      use=“required”/>
    <xs:attribute name=“seq_number” type=“xs:string”
      use=“optional”/>
    <xs:attribute name=“repeatable” type=“xs:boolean”
      use=“optional” default=“false”/>
  </xs:complexType>
</xs:element>
```

For details pertaining to the optional FormSpec [symbol] SectionSpec [symbol] QuestionSpec [symbol] TOCEntry element, see FormSpec [symbol] SectionSpec [symbol] TOCEntry.

For details pertaining to the optional FormSpec [symbol] SectionSpec [symbol] QuestionSpec [symbol] Instructions element, see FormSpec [symbol] SectionSpec [symbol] Instructions.

For details pertaining to the optional FormSpec [symbol] SectionSpec [symbol] QuestionSpec [symbol] HelpSpec element, see FormSpec [symbol] SectionSpec [symbol] HelpSpec.

The optional, repeatable FormSpec [symbol] SectionSpec [symbol] QuestionSpec [symbol] SelectionGroupSpec element specifies a list of choices from which the user can select. Its attributes include:
attribute see FormSpec [symbol] SectionSpec [symbol] QuestionSpec [symbol] attribute
order—see FormSpec [symbol] SectionSpec [symbol] QuestionSpec [symbol] order
prompt—see FormSpec [symbol] SectionSpec [symbol] QuestionSpec [symbol] prompt
min_selections & max_selections—specify how few selections a user must make and how many they may make. For example, a min_selections value of 1 and max_selections value of 1 implies a default presentation and behavior that we commonly associate with radio buttons where one and only one selection is possible for a group of values such as selecting from “Male” or “Female”. A min_selectrons value of 0 implies that the radio button style and behavior is not appropriate since this presentation device does not permit deselection. This implies a tick box style of presentation with max_selections specifying how many selections the user can make.
selection_grouping—defines how to combine lower level selections, either through addition, concatenation, or as discrete answers (e.g., not combined), and may be required. This may be used when a FormSpec [symbol] SectionSpec [symbol] QuestionSpec [symbol] SelectionGroupSpec [symbol] attribute is specified. For example, with “addition” specified, a 1-of-3 SelectionGroupSpec with the first two options selected would have the value “6” if the attribute values for the lower level selections (see FormSpec [symbol] SectionSpec [symbol] QuestionSpec [symbol] SelectionGroupSpec [symbol] SelectionSpec and its attributes attribute_value and unselected_value) are “4”, “2”, and “1” respectively and each has an unselected_value of “0”. With “concatenation” specified, a 1-of-3 SelectionGroupSpec with the first two options selected would have the value “YYN”. (assumes attribute_value and unselected_value of the lower level selections are “Y” and “N” respectively). “Discrete” may be specified if the SelectionSpecs define individual attribute names—meaning that the engine stores answers for each selection option in separate attributes (variables).
selection_group_type—overrides the default behavior of selection groups, which is derived from the values of min_selections and max_selections, and may be optional. It may explicitly specify a “multitick” or “radio” style, or just allow the default behavior.

In certain example embodiments, the XML Instance Representation of a FormSpec [symbol] SectionSpec [symbol] QuestionSpec [symbol] SelectionGroupSpec element may be as follows:

```
<SelectionGroupSpec
  attribute=“xs:string [0..1]”
  order=“xs:unsignedInt [1]”
  prompt=“resourceID_T [0..1]”
  min_selections=“xs:unsignedShort [1]”
  max_selections=“xs:unsignedShort [1]”
  selection_grouping=“selection_grouping_T [1]”
  selection_group_type=“selection_group_type_T [0..1]”>
    <Instructions> ... </Instructions> [0..1]
    <HelpSpec> ... </HelpSpec> [0..*]
    <SelectionSpec> ... </SelectionSpec> [1..*]
</SelectionGroupSpec>
```

In certain example embodiments, the Schema Component Representation of a FormSpec [symbol] SectionSpec [symbol] QuestionSpec [symbol] SelectionGroupSpec element may be as follows:

```
<xs:element name=“SelectionGroupSpec”>
  <xs:complexType>
    <xs:sequence minOccurs=“1” maxOccurs=“1”>
      <xs:element ref=“Instructions” minOccurs=“0”
        maxOccurs=“1”/>
      <xs:element ref=“HelpSpec” minOccurs=“0”
        maxOccurs=“unbounded”/>
      <xs:element ref=“SelectionSpec” minOccurs=“1”
        maxOccurs=“unbounded”/>
    </xs:sequence>
    <xs:attributeGroup ref=“AnswerSpec”/>
    <xs:attribute name=“min_selections”
      type=“xs:unsignedShort” use=“required”/>
    <xs:attribute name=“max_selections”
      type=“xs:unsignedShort” use=“required”/>
    <xs:attribute name=“selection_grouping”
      type=“selection_grouping_T” use=“required”/>
    <xs:attribute name=“selection_group_type”
      type=“selection_group_type_T” use=“optional”
      default=“default”/>
  </xs:complexType>
</xs:element>
```

For details pertaining to the optional FormSpec [symbol] SectionSpec [symbol] QuestionSpec [symbol] SelectionGroupSpec [symbol] Instructions element, see FormSpec [symbol] SectionSpec [symbol] Instructions.

For details pertaining to the optional FormSpec [symbol] SectionSpec [symbol] QuestionSpec [symbol] SelectionGroupSpec [symbol] HelpSpec element, see FormSpec [symbol] SectionSpec [symbol] HelpSpec.

The FormSpec [symbol] SectionSpec [symbol] QuestionSpec [symbol] SelectionGroupSpec [symbol] SelectionSpec may be required and also may have as attributes:
attribute—see FormSpec [symbol] SectionSpec [symbol] QuestionSpec [symbol] attribute
order—see FormSpec [symbol] SectionSpec [symbol] QuestionSpec [symbol] order
prompt—see FormSpec [symbol] SectionSpec [symbol] QuestionSpec [symbol] prompt
attribute_value—specifies what values the engine should use when a user makes a selection. See the discussion of FormSpec [symbol] SectionSpec [symbol] QuestionSpec [symbol] SelectionGroupSpec [symbol] selection_grouping for examples.
unselected_value—specifies what values the engine should use when a user does not make a selection. See FormSpec [symbol] SectionSpec [symbol] QuestionSpec [symbol] SelectionGroupSpec [symbol] selection_grouping for examples.

In certain example embodiments, the XML Instance Representation of a FormSpec [symbol] SectionSpec [symbol] QuestionSpec [symbol] SelectionGroupSpec [symbol] SelectionSpec element may be as follows:

```
<SelectionSpec
  attribute=“xs:string [0..1]”
  order=“xs:unsignedInt [1]”
  prompt=“resourceID_T [0..1]”
  attribute_value=“xs:string [1]”
  unselected_value=“xs:string [0..1]”>
      <Instructions> ... </Instructions> [0..1]
      <HelpSpec> ... </HelpSpec> [0..*]
      <SelectionGroupSpec> ... </SelectionGroupSpec> [0..*]
      <WriteInSpec> ... </WriteInSpec> [0..*]
</SelectionSpec>
```

In certain example embodiments, the Schema Component Representation of a FormSpec [symbol] SectionSpec [symbol] QuestionSpec [symbol] SelectionGroupSpec [symbol] SelectionSpec element may be as follows:

```
<xs:element name=“SelectionSpec”>
    <xs:complexType>
      <xs:sequence minOccurs=“1” maxOccurs=“1”>
        <xs:element ref=“Instructions” minOccurs=“0”
          maxOccurs=“1”/>
        <xs:element ref=“HelpSpec” minOccurs=“0”
          maxOccurs=“unbounded”/>
        <xs:element ref=“SelectionGroupSpec” minOccurs=“0”
          maxOccurs=“unbounded”/>
        <xs:element ref=“WriteInSpec” minOccurs=“0”
          maxOccurs=“unbounded”/>
      </xs:sequence>
      </xs:attributeGroup ref=“AnswerSpec”/>
      <xs:attribute name=“attribute_value” type=“xs:string”
        use=“required”/>
      <xs:attribute name=“unselected_value” type=“xs:string”
        use=“optional”/>
    </xs:complexType>
</xs:element>
```

For details pertaining to the optional FormSpec [symbol] SectionSpec [symbol] QuestionSpec [symbol] SelectionGroupSpec [symbol] SelectionSpec [symbol] Instructions, see FormSpec [symbol] SectionSpec [symbol] Instructions.

For details pertaining to the optional FormSpec [symbol] SectionSpec [symbol] QuestionSpec [symbol] SelectionGroupSpec [symbol] SelectionSpec [symbol] HelpSpec, see FormSpec [symbol] SectionSpec [symbol] HelpSpec.

The FormSpec [symbol] SectionSpec [symbol] QuestionSpec [symbol] SelectionGroupSpec [symbol] SelectionSpec [symbol] SelectionGroupSpec is indicative of nested elements. Through the schema and form engine, nesting of selection groups is supported. This allows a single question to have a first level selection group whose individual selections can in turn specify a list of options. This supports some of the complex constructs that occasionally occur in questionnaires and surveys and is a feature of the schema and form engine. To support this, the schema allows SelectionGroupSpec to be a sub-element of SelectionSpec. The engine may make the nesting level more visible to the user by virtue of outputting a reference to a distinct CSS style that is unique to the nesting level. The depth of nesting is not constrained by the schema or form engine but, in practice, customers may limit the depth to make their questions comprehensible and the service usable.

For details pertaining to the FormSpec [symbol] SectionSpec [symbol] QuestionSpec [symbol] SelectionGroupSpec [symbol] SelectionSpec [symbol] WriteInSpec element, see FormSpec [symbol] SectionSpec [symbol] QuestionSpec [symbol] WriteInSpec below. This is appropriate where for example a final tick box option is “Other” and the user is prompted to write in a response.

The FormSpec [symbol] SectionSpec [symbol] QuestionSpec [symbol] WriteInSpec element defines text entry fields. Its attributes include:
attribute—see FormSpec [symbol] SectionSpec [symbol] QuestionSpec [symbol] attribute.
order—see FormSpec [symbol] SectionSpec [symbol] QuestionSpec [symbol] order.
prompt—see FormSpec [symbol] SectionSpec [symbol] QuestionSpec [symbol] prompt.
display columns—informs the engine of the appropriate horizontal space to allow for the user to enter text.
display_rows informs the engine of the appropriate vertical space to allow for the user to enter text if the form definer wishes to allow multi-line input.
type—enumerates a list that corresponds to HTML field types of “Date”, “TextArea” for multi-fine input, “Text”, and “Select” for combo boxes.

In certain example embodiments, the XML Instance Representation of a FormSpec [symbol] SectionSpec [symbol] QuestionSpec [symbol] WriteInSpec element may be as follows:

```
<WriteInSpec
  attribute=“xs:string [0..1]”
  order=“xs:unsignedInt [1]”
  prompt=“resourceID_T [0..1]”
  display_columns=“xs:unsignedInt [1]”
  display_rows=“xs:unsignedInt [0..1]”
  type=“writeInSpec_T [0..1]”>
      <Instructions> ... </Instructions> [0..1]
      <HelpSpec> ... </HelpSpec> [0..*]
      <ValidationRules> ... </ValidationRules> [0..1]
</WriteInSpec>
```

In certain example embodiments, the Schema Component Representation of a FormSpec [symbol] SectionSpec [symbol] QuestionSpec [symbol] WriteInSpec element may be as follows:

```
<xs:element name=“WriteInSpec”>
    <xs:complexType>
      <xs:sequence minOccurs=“1” maxOccurs=“1”>
        <xs:element ref=“Instructions” minOccurs-“0”
          maxOccurs=“1”/>
        <xs:element ref=“HelpSpec” minOccurs=“0”
          maxOccurs=“unbounded”/>
        <xs:element ref=“ValidationRules” minOccurs=“0”
          maxOccurs=“1”/>
      </xs:sequence>
      <xs:attributeGroup ref=“AnswerSpec”/>
      <xs:attribute name=“display_columns”
        type=“xs:unsignedInt” use=“required”/>
      <xs:attribute name=“display_rows”
        type=“xs:unsignedInt” use=“optional” default=“1”/>
      <xs:attribute name=“type” type=“writeInSpec_T”
        use=“optional” default=“Text”/>
    </xs:complexType>
</xs:element>
```

For details pertaining to the optional FormSpec [symbol] SectionSpec [symbol] QuestionSpec [symbol] WriteInSpec [symbol] Instructions element, see FormSpec [symbol] SectionSpec [symbol] Instructions.

For details pertaining to the optional FormSpec [symbol] SectionSpec [symbol] QuestionSpec [symbol] WriteInSpec [symbol] HelpSpec element, see FormSpec [symbol] SectionSpec [symbol] HelpSpec.

The FormSpec [symbol] SectionSpec [symbol] QuestionSpec [symbol] WriteInSpec [symbol] ValidationRules element defines rules that the engine is to use to validate typed in user inputs. This sub-clement occurs no more than once, but multiple instances of multiple rules through sub-elements of ValidationRules can be defined.

In certain example embodiments, the XML Instance Representation of a FormSpec [symbol] SectionSpec [symbol] QuestionSpec [symbol] WriteInSpec [symbol] ValidationRules element may be as follows:

```
<ValidationRules>
    <LengthRule> ... </LengthRule> [0..*]
    <RangeRule> ... </RangeRule> [0..*]
    <EnumerationRule> ... </EnumerationRule> [0..*]
    <DateRule> ... </DateRule> [0..*]
    <ExitRule> ... </ExitRule> [0..*]
</ValidationRules>
```

In certain example embodiments, the Schema Component Representation of a FormSpec [symbol] SectionSpec [symbol] QuestionSpec [symbol] WriteInSpec [symbol] ValidationRules element may be as follows:

```
<xs:element name=“ValidationRules”>
    <xs:complexType>
      <xs:sequence minOccurs=“1” maxOccurs=“1”>
        <xs:element ref=“LengthRule” minOccurs=“0”
          maxOccurs=“unbounded”/>
        <xs:element ref=“RangeRule” minOccurs=“0”
          maxOccurs=“unbounded”/>
        <xs:element ref=“EnumerationRule” minOccurs=“0”
          maxOccurs=“unbounded”/>
        <xs:element ref=“DateRule” minOccurs=“0”
          maxOccurs=“unbounded”/>
        <xs:element ref=“ExitRule” minOccurs=“0”
          maxOccurs=“unbounded”/>
      </xs:sequence>
    </xs:complexType>
</xs:element>
```

The FormSpec [symbol] SectionSpec [symbol] QuestionSpec [symbol] WriteInSpec [symbol] ValidationRules [symbol] LengthRule element has as its attributes:
min & max—specify the minimum and maximum number of characters respectively that the engine will require or permit the user to enter.

In certain example embodiments, the XML Instance Representation of a FormSpec [symbol] SectionSpec [symbol] QuestionSpec [symbol] WriteInSpec [symbol] ValidationRules [symbol] LengthRule element may be as follows:

```
<LengthRule
  min=“xs:nonNegativeInteger [1]”
  max=“xs:nonNegativeInteger [1]”/>
```

In certain example embodiments, the Schema Component Representation of a FormSpec [symbol] SectionSpec [symbol] QuestionSpec [symbol] WriteInSpec [symbol] ValidationRules [symbol] LengthRule element may be as follows:

```
<xs:element name=“LengthRule”>
    <xs:complexType>
      <xs:attribute name=“min” type=“xs:nonNegativeInteger”
        use=“required”/>
      <xs:attribute name=“max” type=“xs:nonNegativeInteger”
        use=“required”/>
    </xs:complexType>
</xs:element>
```

The FormSpec [symbol] SectionSpec [symbol] QuestionSpec [symbol] WriteInSpec [symbol] ValidationRules [symbol] RangeRule element may have as its attributes:
min & max—Defines min and max attributes specifying a numeric range that bounds the user's entries,

In certain example embodiments, the XML Instance Representation of a FormSpec [symbol] SectionSpec [symbol] QuestionSpec [symbol] WriteInSpec [symbol] ValidationRules [symbol] RangeRule element may be as follows:

```
<RangeRule
  min=“xs:integer [1]”
  max=“xs:integer [1]”/>
```

In certain example embodiments, the Schema Component Representation of a FormSpec [symbol] SectionSpec [symbol] QuestionSpec [symbol] WriteInSpec [symbol] ValidationRules [symbol] RangeRule element may be as follows:

```
<xs:element name=“RangeRule”>
    <xs:complexType>
      <xs:attribute name=“min” type=“xs:integer”
        use=“required”/>
      <xs:attribute name=“max” type=“xs:integer”
        use=“required”/>
    </xs:complexType>
</xs:element>
```

The FormSpec [symbol] SectionSpec [symbol] QuestionSpec [symbol] WriteInSpec [symbol] ValidationRules [symbol] EnumerationRule may have as its attributes:
constrained_ind—specifies whether a “Select” or combo box type of WriteInSpec will constrain the user to the list of values enumerated in the combo box or permit the user to type in their own response.

In certain example embodiments, the XML Instance Representation of a FormSpec [symbol] SectionSpec [symbol] QuestionSpec [symbol] WriteInSpec [symbol] ValidationRules [symbol] EnumerationRule element may be as follows:

```
<EnumerationRule
  constrained_ind=“xs:boolean [0..1]”>
      <Enum> ... </Enum> [2..*]
</EnumerationRule>
```

In certain example embodiments, the Schema Component Representation of a FormSpec [symbol] SectionSpec [symbol] QuestionSpec [symbol] WriteInSpec [symbol] ValidationRules [symbol] EnumerationRule element may be as follows:

```
<xs:element name=“EnumerationRule”>
    <xs:complexType>
      <xs:sequence minOccurs=“1” maxOccurs=“1”>
        <xs:element ref=“Enum” minOccurs=“2”
          maxOccurs=“unbounded”/>
      </xs:sequence>
      <xs:attribute name=“constrained_ind” type=“xs:boolean”
        default=“true” use=“optional”/>
    </xs:complexType>
</xs:element>
```

At least two FormSpec [symbol] SectionSpec [symbol] QuestionSpec [symbol] WriteInSpec [symbol] ValidationRules [symbol] EnumerationRule [symbol] Enum elements may be required. Each may have as its attributes:
value—defines an optional literal value that the engine will put into the “attribute” (variable) for the WriteInSpec.
text—a resource ID pointing to the actual text the engine is to show in the combo box.

In certain example embodiments, the XML Instance Representation of a FormSpec [symbol] SectionSpec [symbol] QuestionSpec [symbol] WriteInSpec [symbol] ValidationRules [symbol] EnumerationRule [symbol] Enum element may be as follows:

```
<Enum
  Value=“xs:string [0..1]”
  text=“resourceID_T [1]”/>
```

In certain example embodiments, the Schema Component Representation of a FormSpec [symbol] SectionSpec [symbol] QuestionSpec [symbol] WriteInSpec [symbol] ValidationRules [symbol] EnumerationRule [symbol] Enum element may be as follows:

```
<xs:element name=“Enum”>
    <xs:complexType>
      <xs:attribute name=“value” type=“xs:string”
        use=“optional”/>
      <xs:attribute name=“text” type=“resourceID_T”
        use=“required”/>
    </xs:complexType>
</xs:element>
```

The FormSpec [symbol] SectionSpec [symbol] QuestionSpec [symbol] WriteInSpec [symbol] ValidationRules [symbol] EnumerationRule [symbol] DateRule element validates that an input date is in the correct format and is semantically correct (e.g., number of days in February—based on Leap Years) and can check that the entered value is within a range. Its attributes include:
dateFrom & dateTo—inclusive of the date(s) specified.
dateFormat specifics a pattern such as “mm/dd/yyyy” or “dd-mon-yyyy”. Note that “mon” validation may depend on the user's language selection.

In certain example embodiments, the XML Instance Representation of a FormSpec [symbol] SectionSpec [symbol] QuestionSpec [symbol] WriteInSpec [symbol] ValidationRules [symbol] EnumerationRule [symbol] DateRule element may be as follows:

```
<DateRule>
    <DateFormat> xs:string </DateFormat> [1..*]
    <DateFrom> xs:string </DateFrom> [0..1]
    <DateTo> xs:string </DateTo> [0..1]
</DateRule>
```

In certain example embodiments, the Schema Component Representation of a FormSpec [symbol] SectionSpec [symbol] QuestionSpec [symbol] WriteInSpec [symbol] ValidationRules [symbol] EnumerationRule [symbol] DateRule element may be as follows:

```
<xs:element name=“DateRule”>
    <xs:complexType>
      <xs:sequence minOccurs=“1” maxOccurs=“1”>
        <xs:element name=“DateFormat” type=“xs:string”
          minOccurs=“1” maxOccurs=“unbounded”/>
        <xs:element name=“DateFrom” type=“xs:string”
          minOccurs=“0” maxOccurs=“1”/>
        <xs:element name=“DateTo” type=“xs:string”
          minOccurs=“0” maxOccurs=“1”/>
      </xs:sequence>
    </xs:complexType>
</xs:element>
```

The FormSpec [symbol] SectionSpec [symbol] QuestionSpec [symbol] WriteInSpec [symbol] ValidationRules [symbol] EnumerationRule [symbol] ExitRule element is a feature of the schema and the form engine that helps allow for the extension of the engine without changing the coding of the engine itself. The computer language in which the engine and the exit rules are written may support dynamic call resolution such as that provided by the Java language. These exit routines can greatly extend the engine's ability to perform validation of user inputs. Its attributes include:
exit_name—defines an Exit.

In certain example embodiments, the XML Instance Representation of a FormSpec [symbol] SectionSpec [symbol] QuestionSpec [symbol] WriteInSpec [symbol] ValidationRules [symbol] EnumerationRule [symbol] ExitRule element may be as follows:

```
<ExitRule
  exit_name=“xs:string [1]”>
    <InputAttribute> xs:string </InputAttribute> [1..*]
    <InputLiteral> xs:string </InputLiteral> [0..*]
    <OutputAttribute> xs:string </OutputAttribute> [0..*]
</ExitRule>
```

In certain example embodiments; the Schema Component Representation of a FormSpec [symbol] SectionSpec [symbol] QuestionSpec [symbol] WriteInSpec [symbol] ValidationRule [symbol] EnumerationRule [symbol] DateRule element may be as follows:

```
<xs:element name=“ExitRule”>
    <xs:complexType>
      <xs:sequence minOccurs=“1” maxOccurs=“1”>
        <xs:element name=“InputAttribute” type=“xs:string”
          minOccurs=“1” maxOccurs=“unbounded”/>
        <xs:element name=“InputLiteral” type=“xs:string”
          minOccurs=“0” maxOccurs=“unbounded”/>
        <xs:element name=“OutputAttribute” type=“xs:string”
          minOccurs=“0” maxOccurs=“unbounded”/>
      </xs:sequence>
      <xs:attribute name=“exit_name” type=“xs:string”
        use=“required”/>
    </xs:complexType>
</xs:element>
```

The FormSpec [symbol] SectionSpec [symbol] QuestionSpec [symbol] WriteInSpec [symbol] ValidationRules [symbol] EnumerationRule [symbol] ExitRule [symbol] InputAtribute element, which may be required, is an array of input strings that are the value(s) of one or more attributes (variables).

The optional FormSpec [symbol] SectionSpec [symbol] QuestionSpec [symbol] WriteInSpec [symbol] ValidationRules [symbol] EnumerationRule [symbol] ExitRule [symbol] InputLiteral element is an array of literal values.

The optional FormSpec [symbol] SectionSpec [symbol] QuestionSpec [symbol] WriteInSpec [symbol] ValidationRules [symbol] EnumerationRule [symbol] ExitRule [symbol] OutputAttribute element is an array of strings that the engine will output and assign to the specified attributes (variables).

Exit routines may also output an error message ID if the validation fails that is the resource ID from which the engine should retrieve the text of an error message. As with all text contained in resource files, these error messages may include references to attributes (variables) that the engine will substitute with the current value of the attributes before outputting them.

For further detail pertaining to the FormSpec [symbol] SectionSpec [symbol] QuestionSpec [symbol] ValidationRules element, see FormSpec [symbol] SectionSpec [symbol] QuestionSpec [symbol] WriteInSpace [symbol] ValidationRules.

For further detail pertaining to the FormSpec [symbol] SectionSpec [symbol] QuestionSpec [symbol] SkipSpec element, see FormSpec [symbol] SkipSpec. QuestionSpecs can contain SkipSpec sub-elements either directly or through an indirect reference by SkipSpecRef sub-elements to SkipSpees defined as sub-elements of FormSpec. See the discussion of SkipSpec as part of the description of FormSpec.

The FormSpec [symbol] SkipSpec element defines conditions under which the engine is to skip the presentation of specific questions. This ability to conditionally display questions is a feature of the engine that helps to properly present the appropriate questions based on answers to prior questions and is an aspect of the schema and form engine. For example, it is inappropriate to present a lengthy series of questions related to educational and work experience for a child below a certain age. A paper questionnaire will commonly give an instruction that says to go to another question number based on the user's answer to the current question. A direct electronic analog is possible, but less efficient for the user and unnecessarily introduces the possibility of errors if the user does not follow the instructions. Thus, this element can be defined to introduce the concept of skip patterns, which the engine enforces. A SkipSpec generally is defined at the FormSpec level with an id attribute so that they can be used across multiple questions. They also can be specified in-line within QuestionSpecs.

Continuing the example, it is possible to write a SkipSpec that takes the age response for a person and compares it to a fixed value such as 16 (or the response to another question or a result returned from an ExitRule routine). For each question that the questionnaire says should not ask for persons less than 16, a reference to the SkipSpec may he written, which causes the engine to skip over the questions, saving the user the time and aggravation of manually bypassing irrelevant questions, SkipSpec conditionals may include the usual choices such as less than, greater than or equal, not equal, as well as the Booleans “AND”, “OR”, and “XOR”.

References may be written to multiple skip specs that, the engine combines through a logical “OR”. This allows the engine to skip a question if the answer to any one of a number of previously answered questions causes the engine to evaluate a corresponding referenced SkipSpec as “TRUE”. “The schema provides a means in a SkipSpec to define an AndIf element, allowing us to define “AND” logical constructs between SkipSpecs as well. Through indirect references to a SkipSpec, the specification of a conditional can be changed once and have an affect on the engine's navigation through all referencing question specifications in the form. As the user navigates back and forth through the form, the user may change answers to questions that mean that the engine must display and process previously skipped questions or discard previously entered responses to questions that the engine had displayed.

In certain example embodiments, the XML Instance Representation of a FormSpec [symbol] SkipSpec element may be as follows:

```
<SkipSpec
  id=“skipSpecID_T [0..1]”>
    <Attribute> xs:string </Attribute> [1]
    <Conditional> conditional_T </Conditional> [1]
    Start Choice [1]
      <Attribute> xs:string </Attribute> [1]
      <Value> xs:string </Value> [1]
    End Choice
    <AndIf> SkipSpec_T </AndIf> [0..1]
</SkipSpec>
```

In certain example embodiments, the Schema Component Representation of a FormSpec [symbol] SkipSpec element may be as follows:
<xs:element name=“SkipSpec” type=“SkipSpec_T”/>

The FormSystem element helps to organize multiple XML form definitions (instantiations of documents that follow the FormSpec schema) info a complete set of form definitions. This allows a single instance of the form engine to differentiate form definitions, for example, by customer and by type. Its attributes include:
resource_location—points the engine to a resource file.
CSS_location—points the engine to a CSS file.
Resources—corresponds to the text referenced by a resource ID key, and applies to all customers and forms unless overridden at a lower level.
CSS styles—applies to all customers and forms unless overridden at a lower level.

The FormSystem [symbol] Customers element (specified as sub-elements to the “Customers” sub-element of Form System) may be used in whole or in part, or may be overridden. For example, to make error message wording more culturally appropriate or to implement a common style that is consistent with a customer's “branding.” A single physical instantiation of a form engine and its associated infrastructure may support multiple customers who have agreed to share the system's resources, but have distinct questionnaire/survey/form requirements.

The FormSystem [symbol] Customers [symbol] Customer element may have as attributes:
name—allows forms to be readily differentiated and helps ensure that the front end of the form engine does not present form choices to users that are not appropriate for the customer with which the user is associated. This provides part of the mechanism through which the definitions in the form, system can be tied to authentication modules that verify a user's unique identifying information (e.g., an Internet Access Code or userid and password) to the customer and form type appropriate for the user.
resource_location—points the engine to a resource file.
CSS_location—point the engine to a CSS file.

FormSystem [symbol] Customers [symbol] Customer [symbol] FormSpecs—defines language dependent resources and styles within a FormSpec. Its attributes include:
formSpec_location—points to actual form definition XML documents. A census customer, for example, may have multiple form definitions that are appropriate for households, individuals, and communal establishments.

The FormSystem [symbol] Customers [symbol] Customer [symbol] FormSpecRef element may define resources and styles that are form specific but language independent. Its attributes include:
resource_location—points the engine to a resource file.
CSS_location—point the engine to a CSS file.

5.5.3 Example Global Definitions in Example XSD

The following example global definitions may be implemented in connection with the above-specified example schema document properties and example global declarations.

The AnswerSpec attribute group may have the following example XML instance representation:

attribute=“xs:string [0..1]”
order=“xs:unsignedInt [1]”
prompt=“resourceID_T [0..1]”

The AnswerSpec attribute group may have the following example schema component representation:

```
<xs:attributeGroup name=“AnswerSpec”>
    <xs:attribute name=“attribute” type=“xs:string”
      use=“optional”/>
    <xs:attribute name=“order” type=“xs:unsignedInt”
      use=“required”/>
    <xs:attribute name=“prompt” type=“resourceID_T”
      use=“optional”/>
</xs:attributeGroup>
```

If multiple SkipSpecs are coded together at the same level, they are logically joined by “OR.” The “andIf” element may be used for logical “AND” between conditions. In this regard, the complex type SkipSpec_T may have the following example XML instance representation:

```
<...
  id=“skipSpecID_T [0..1]”>
    <Attribute> xs:string </Attribute> [1]
    <Conditional> conditional_T </Conditional> [1]
    Start Choice [1]
      <Attribute> xs:string </Attribute> [1]
      <Value> xs:string </Value> [1]
    End Choice
    <AndIf> SkipSpec_T </AndIf> [0..1]
</...>
```

The complex type SkipSpec_T may have the following example schema component representation:

```
<xs:complexType name=“SkipSpec_T”>
    <xs:sequence>
      <xs:element name=“Attribute” type=“xs:string”
        minOccurs=“1” maxOccurs=“1”/>
      <xs:element name=“Conditional” type=“conditional_T”
        minOccurs=“1” maxOccurs=“1”/>
      <xs:choice>
        <xs:element name=“Attribute” type=“xs:string”
          minOccurs=“1” maxOccurs=“1”/>
        <xs:element name=“Value” type=“xs:string”
          minOccurs=“1” maxOccurs=“1”/>
      </xs:choice>
      <xs:element name=“AndIf” type=“SkipSpec_T”
        minOccurs=“0” maxOccurs=“1”/>
    </xs:sequence>
    <xs:attribute name=“id” type=“SkipSpecID_T”
      use=“optional”/>
</xs:complexType>
```

The simple type commit_level_T has, as a super-type, the xs:string type. In other words, its base XSD type is a string. Its value comes from the list comprising: {‘section’|‘page’}. The simple type commit_level_T may have the following example schema component representation:

```
<xs:simpleType name=“commit_level_T”>
    <xs:restriction base=“xs:string”>
      <xs:enumeration value=“section”/>
      <xs:enumeration value=“page”/>
    </xs:restriction>
</xs:simpleType>
```

The simple type conditional_T has, as a super-type, the xs: string type. In other words, its base XSD type is a string. Its value comes from the list comprising: {‘EQ’|‘NE’|‘LT’|‘LE’|‘GW’|‘GT’|‘AND’|‘OR’|‘XOR’}. The simple type conditional_T may have the following example schema component representation:

```
<xs:simpleType name=“conditional_T”>
    <xs:restriction base=“xs:string”>
      <xs:enumeration value=“EQ”/>
      <xs:enumeration value=“NE”/>
      <xs:enumeration value=“LT”/>
      <xs:enumeration value=“LE”/>
      <xs:enumeration value=“GE”/>
      <xs:enumeration value=“GT”/>
      <xs:enumeration value=“AND”/>
      <xs:enumeration value=“OR”/>
      <xs:enumeration value=“XOR”/>
    </xs:restriction>
</xs:simpleType>
```

The simple type resourceID_T has, as a super-type, the xs:string type. In other words, its base XSD type is a string. The simple type resourceID_T may have the following example schema component representation:

<xs:simpleType name=“resourceID_T”>
<xs:restriction base=“xs:string”/>
</xs:simpleType>

The simple type selection_group_type_T has, as a super-type, the xs:string type. In other words, its base XSD type is a string. Its value comes from the list comprising: {‘default’|‘multitick’|‘radio’}. It may allow the default behavior of selection groups to be overridden, based on min_selections and max_selections, for example, if the maximum is 1, then the default is “radio”(unless there is only one SelectionSpec); otherwise it will be a “multitick.” If the minimum is 0, then a response is not required for this SelectionGroup, although a response may still be required for the Question. There may be several selection groups in a question, each having a minimum of 0. If the question itself is not marked as optional, there must still be a selection in at least one selection group or an entry in a write-in for the user to proceed. The simple type selection_group_type_T may have the following example schema component representation:

```
xs:simpleType name=“selection_group_type_T”>
    <xs:restriction base=“xs:string”>
      <xs:enumeration value=“default”/>
      <xs:enumeration value=“multitick”/>
      <xs:enumeration value=“radio”/>
    </xs:restriction>
</xs:simpleType>
```

The simple type selection_grouping_T has, as a super-type, the xs:string type. In other words, its base XSD type is a string. Its value comes from the list comprising: {‘addition’|‘concatenation’|‘discrete’}. The simple type selection_grouping_T may have the following example schema component representation:

```
<xs:simpleType name=“selection_grouping_T”>
    <xs:restriction base=“xs:string”>
      <xs:enumeration value=“addition”/>
      <xs:enumeration value=“concatenation”/>
      <xs:enumeration value=“discrete”/>
    </xs:restriction>
</xs:simpleType>
```

The simple type skipSpecID_T has, as a super-type, the xs:string type. In other words, its base XSD type is a siring. The simple type skipSpecID_T may have the following example schema component representation:

<xs:simpleType name=“skipSpecID_T”>
<xs:restriction base=“xs:string”/>
</xs:simpleType>

The simple type writeInSpec_T is an enumerated list of WriteInSpectTypes corresponding to HTML field types. It has, as a super-type, the xs:string type. In other words, its base XSD type is a string. Its value comes from the list, comprising: {‘Date’|‘TextArea’|‘Text’|‘Select’}. The simple type writeInSpec_T may have the following example schema component representation:

```
<xs:simpleType name=“writeInSpec_T”>
    <xs:restriction base=“xs:string”>
      <xs:enumeration value=“Date”/>
      <xs:enumeration value=“TextArea”/>
      <xs:enumeration value=“Text”/>
      <xs:enumeration value=“Select”/>
    </xs:restriction>
</xs:simpleType>
```

5.5.4 Summary of Example Schema Structure

It will be appreciated that the above-described example schema may be comprised of any suitable combination of the schema document properties, global declarations, and/or global definitions detailed herein. It also will be appreciated that such components may be combined in any suitable combination or sub-combination to produce yet further schemas appropriate for use in connection with further embodiments. Moreover, it will be appreciated that the schema document properties, global declarations, and/or global definitions detailed herein may be provided to produce any number of combinations and sub-combinations of survey techniques that provide any number of attendant features, aspects, and/or advantages.

For instance, in certain example embodiments, a computer-readable storage medium tangibly storing a schema may be provided. The schema is readable by a forms engine configured to dynamically conduct a computer-accessible online survey in dependence on the schema. The schema comprises a plurality of elements arranged hierarchically. Each said element comprises one or more elements and/or attributes. Each said attribute includes descriptive information associated with a corresponding element. Pointers are associated with at least some of the demerits and/or attributes. The pointers point to text and/or images to be selectively included in the online survey but are stored separately from the schema such that the schema is substantially free from hard-coded text and/or images that otherwise would be included in the online survey. At least some of the elements and/or attributes dynamically instruct the forms engine whether to ask, repeatedly ask, or skip a question or section of questions pointed to by one or more of said pointers.

As an other example, a method of conducting a computer-accessible online survey may be provided. The method comprises presenting one or more response pages for a respondent to complete in connection with the online survey. The one or more response pages are dynamically generated by a forms engine in dependence on a schema tangibly stored in a computer-readable storage medium. The schema comprises a plurality of elements arranged hierarchically. Each said element comprises one or more elements and/or attributes. Each said attribute includes descriptive information associated with a corresponding element. Pointers arc associated with at least some of the elements and/or attributes. The pointers point to text and/or images to be selectively included in the online survey but are stored separately from the schema such that the schema is substantially free from hard-coded text and/or images that otherwise would be included in the online survey. At least some of the elements and/or attributes dynamically instruct the forms engine whether to ask, repeatedly ask, or skip a question or section of questions pointed to by one or more of said pointers.

In still another example, a system for conducting a computer-accessible online survey may be provided. A schema is tangibly stored in a computer-readable storage medium. A forms engine is configured to dynamically process the schema in conducting the survey. The schema comprises a plurality of elements arranged hierarchically. Each said element comprises one or more elements and/or attributes. Each said attribute includes descriptive information associated with a corresponding element. Pointers are associated with at least some of the elements and/or attributes. The pointers point to text and/or images to be selectively included in the online survey but are stored separately from the schema such that the schema is substantially free from hard-coded text and/or images that otherwise would be included in the online survey. At least some of the elements and/or attributes dynamically instruct the forms engine whether to ask, repeatedly ask, or skip a question or section of questions pointed to by one or more of said pointers.

As noted above, in connection with these and/or other techniques, a variety of features, aspects, and/or advantages may be provided, for instance, at least some of the pointers may be changeable, e.g., based on user input. The changeable pointers may be configured to support a request for a language change dynamically. The text and/or images pointed to by the pointers also may be changeable substantially independent of the schema. Similarly, a formal of the survey may be changeable, in whole or in part, substantially independent of the schema. The format may correspond to look-and-feel, navigation, etc. Also, at least some of the elements and/or attributes may dynamically instruct the forms engine whether to ask, repeatedly ask, or skip a question or section of questions pointed to by one or more of said pointers in dependence on at least one previous answer.

At least some of the elements and/or attributes are configured to provide context-sensitive help to a user of the survey. In a similar fashion, at least some of the elements and/or attributes may have corresponding error-checking logic, and at least some of the elements and/or attributes are configured to instruct the survey to display an error message in response to the error-checking logic. A progress indicator may be dynamically updatable based in part on the elements and/or attributes that dynamically instruct the forms engine whether to ask, repeatedly ask, or skip a question or section of questions pointed to by one or more of said pointers.

At least some of the elements and/or attributes may dynamically instruct the forms engine whether and where to persist answers to questions. Modular authentication programmed logic circuitry also may be provided. In certain example embodiments, the schema may be an XML schema.

### 6. Conclusions

The example embodiments described herein provide a secure, cost-effective, standards-based middleware platform. They may include a flexible response metadata specification, as well as a standards-based look-and-feel specification (e.g., using style sheets). Certain example embodiments also may provide a standards-based service-oriented architecture (SOA) compatible output.

Although certain example embodiments have been described in relation to census-related activities, it will be appreciated that the example embodiments may be used in connection with other markets and/or to meet other needs. For example, certain example embodiments may be applied to any form of online surveys. Indeed, the features and the flexibility described herein may be capable of supporting the online survey market.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention. Also, the various embodiments described above may be implemented in conjunction with other embodiments, e,g., aspects of one embodiment may be combined with aspects of another embodiment to realize yet other embodiments.

1.-38. (canceled)

39. A computer-readable storage medium tangibly storing a schema, the schema, being readable by a forms engine configured to dynamically conduct a computer-accessible online survey in dependence on the schema, the schema comprising:
a plurality of elements arranged hierarchically, each said element comprising one or more elements and/or attributes, each said attribute including descriptive information associated with a corresponding element; and
pointers associated with at least some of the elements and/or attributes, the pointers pointing to text and/or images to be selectively included in the online survey but being stored separately from the schema such that the schema is substantially free from hard-coded text and/or images that otherwise would be included in the online survey,
wherein at least some of the elements and/or attributes dynamically instruct the forms engine whether to ask, repeatedly ask, or skip a question or section of questions pointed to by one or more of said pointers.

40. The computer-readable storage medium of claim 39, wherein at least some of the pointers are changeable based on user input.

41. The computer-readable storage medium of claim 40, wherein the changeable pointers are configured to support a request for a language change dynamically.

42. The computer-readable storage medium of claim 30, wherein the text and/or images pointed to by the pointers is changeable substantially independent of the schema.

43. The computer-readable storage medium of claim 39, wherein a format of the survey is changeable, in whole or in part, substantially independent of the schema.

44. The computer-readable storage medium of claim 43, wherein the format corresponds to look-and-feel.

45. The computer-readable storage medium of claim 43, wherein the format corresponds to navigation.

46. The computer-readable storage medium of claim 39, wherein at least some of the elements and/or attributes dynamically instruct the forms engine whether to ask, repeatedly ask, or skip a question or section of questions pointed to by one or more of said pointers in dependence on at least one previous answer.

47. The computer-readable storage medium of claim 39, wherein at least some of the elements and/or attributes are configured to provide context-sensitive help to a user of the survey.

48. The computer-readable storage medium of claim 39, wherein at least some of the elements and/or attributes have corresponding error-checking logic.

49. The computer-readable storage medium of claim 48, wherein at least some of the elements and/or attributes are configured to instruct the survey to display an error message in response to the error-checking logic.

50. The computer-readable storage medium of claim 48, further comprising a progress indicator dynamically updatable based in part on the elements and/or attributes that dynamically instruct the forms, engine whether to ask, repeatedly ask, or skip a question or section of questions pointed to by one or more of said pointers.

51. The computer-readable storage medium of claim 39, wherein at least some of the elements and/or attributes dynamically instruct the forms engine whether and where to persist answers to questions.

52. The computer-readable storage medium of claim 39, further comprising modular authentication programmed logic circuitry.

53. The computer-readable storage medium of claim 39, wherein the schema is an XML schema.

54. A method of conducting a computer-accessible online survey, the method comprising presenting one or more response pages for a respondent to complete in connection with the online survey, the one or more response pages being dynamically generated by a forms engine in dependence on a schema tangibly stored in a computer-readable storage medium, the schema comprising:
a plurality of elements arranged hierarchically, each said element comprising one or more elements and/or attributes, each said attribute including descriptive information associated with a corresponding element; and
pointers associated with at least some of the elements and/or attributes, the pointers pointing to text and/or images to be selectively included in the online survey but being stored separately from the schema such that the schema is substantially free from hard-coded text and/or images that otherwise would be included in the online survey.
wherein at least some of the elements and/or attributes dynamically instruct the forms engine whether to ask, repeatedly ask, or skip a question or section of questions pointed to by one or more of said pointers.

55. The method of claim 54, further comprising changing at least some of the pointers based on respondent input.

56. The method of claim 55, further comprising responding to a request for a language change by dynamically changing at least some of the pointers.

57. The method of claim 54, further comprising changing the text and/or images pointed to by the pointers substantially independent of the schema.

58. The method of claim 54, further comprising changing a format of the survey, in whole or in part, substantially independent of the schema.

59. The method of claim 58, wherein the format corresponds to look-and-feel.

60. The method of claim 58, wherein the format corresponds to navigation.

61. The method of claim 54, further comprising dynamically instructing the forms engine, via at least some of the elements and/or attributes, whether to ask, repeatedly ask, or skip a question or section of questions pointed to by one or more of said pointers in dependence on at least one previous answer.

62. The method of claim 54, further comprising providing, via at least some of the elements and/or attributes, context-sensitive help to the respondent.

63. The method of claim 54, wherein at least some of the elements and/or attributes have corresponding error-checking logic.

64. The method of claim 63, further comprising displaying an error message in response to the error-checking logic.

65. The method of claim 54, further comprising dynamically updating a progress indicator based in part on the elements and/or attributes that dynamically instruct the forms engine whether to ask, repeatedly ask, or skip a question or section of questions pointed to by one or more of said pointers.

66. The method of claim 54, further comprising persist answers to questions in dependence on at least some of the elements and/or attributes.

67. The method of claim 54, further comprising providing modular authentication programmed logic circuitry.

68. The method of claim 54, wherein the schema is an XML schema.

69. A system for conducting a computer-accessible online survey, comprising:
a schema tangibly stored in a computer-readable storage medium; and
a forms engine configured to dynamically process the schema in conducting the survey,
wherein the schema comprises:
a plurality of elements arranged hierarchically; each said element comprising one or more elements and/or attributes, each said attribute including descriptive information associated with a corresponding element; and
pointers associated with at least some of the elements and/or attributes, the pointers pointing to text and/or images to be selectively included in the online survey but being stored separately from the schema such that the schema is substantially free from hard-coded text and/or images that otherwise would be included in the online survey,
wherein at least some of the elements and/or attributes dynamically instruct the forms engine whether to ask, repeatedly ask, or skip a question or section of questions pointed to by one or more of said pointers.

70. The system of claim 69, wherein at least some of the pointers are changeable based on user input.

71. The system of claim 70, wherein the changeable pointers are configured to support a request for a language change dynamically.

72. The system of claim 69, wherein the text and/or images pointed to by the pointers is changeable substantially independent of the schema.

73. The system of claim 69, wherein a format of the survey is changeable, in whole or in part, substantially independent of the schema.

74. The system of claim 73, wherein the format corresponds to look-and-feel.

75. The system of claim 73, wherein the format corresponds to navigation.

76. The system of claim 69, wherein at least some of the elements and/or attributes dynamically instruct the forms engine whether to ask, repeatedly ask, or skip a question or section of questions pointed to by one or more of said pointers in dependence on at least one previous answer.

77. The system of claim 69, wherein at least some of the elements and/or attributes are configured to provide context-sensitive help to a user of the survey.

78. The system of claim 69, wherein at least some of the elements and/or attributes have corresponding error-checking logic.

79. The system of claim 78, wherein at least some of the elements and/or attributes are configured to instruct the survey to display an error message in response to the error-checking logic.

80. The system of claim 78, further comprising a progress indicator dynamically updatable based in part on the elements and/or attributes that dynamically instruct the forms engine whether to ask, repeatedly ask, or skip a question or section of questions pointed to by one or more of said pointers.

81. The system of claim 79, wherein at least some of the elements and/or attributes dynamically instruct the forms engine whether and where to persist answers to questions.

82. The system of claim 79, further comprising modular authentication programmed logic circuitry.

83. The system of claim 79, wherein the schema is an XML schema.

84. A computer-readable storage medium tangibly storing a schema, the schema being readable by a forms engine configured to dynamically conduct a computer-accessible online survey in dependence on the schema, the schema comprising;
a plurality of elements arranged hierarchically, each said element comprising one or more elements and/or attributes, each said attribute including descriptive information associated with a corresponding element; and
at least one pointer associated with at least some of the elements and/or attributes, the at least one pointer pointing to text and/or images to be selectively included in the online survey but being stored separately from the schema.

85. A method of conducting a computer-accessible online survey, the method comprising presenting one or more response pages for a respondent to complete in connection with the online survey, the one or more response pages being dynamically generated by a forms engine in dependence on the schema stored in the computer-readable storage medium of claim 84.

86. A system for conducting a computer-accessible online survey, comprising:
the schema stored in the computer-readable storage medium of claim 84; and
a forms engine configured to dynamically process the schema in conducting the survey.
